(19) United States
(12) Patent Application Publication
(10) Pub. No.: US 2024/0246749 A1
(43) Pub. Date: Jul. 25, 2024

(54) KEG CAP AND KEG INCLUDING KEG CAP

(71) Applicant: INTHEKEG, INC., Seoul (KR)

(72) Inventors: Taeil KANG, Seoul (KR); Wonseok LEE, Gwangmyeong-si, Gyeonggi-do (KR); Changhun JEONG, Gunpo-si, Gyeonggi-do (KR); Byunggyu KANG, Seongnam-si, Gyeonggi-do (KR); Seungchul LEE, Seoul (KR); Yoonsang KIM, Seoul (KR)

(73) Assignee: INTHEKEG, INC., Seoul (KR)

(21) Appl. No.: 18/012,643

(22) PCT Filed: Oct. 26, 2020
(86) PCT No.: PCT/KR2020/014682

§ 371 Date: Jun. 29, 2023

(30) Foreign Application Priority Data
Jun. 24, 2020 (KR) 10-2020-0077456

(51) Int. Cl. B65D 85/804; B67D 1/08

(52) U.S. Cl. CPC B65D 85/8043; B67D 1/0831

(57) ABSTRACT

The present invention relates to a device and a method for manufacturing fermented beverage and, more specifically, to a device and a method for manufacturing fermented beverage, wherein handmade fermented beverage can be manufactured without expert knowledge and brewing equipment. An embodiment of the present invention may provide a fermented beverage manufacturing device comprising a flow channel module connected to a keg in which an undiluted solution is stored, wherein the flow channel module comprises: a undiluted solution flow channel provided such that an undiluted solution moves therethrough; a gas flow channel provided such that gas moves therethrough; a coupler provided to independently connect the inside of the keg to the undiluted solution flow channel and the gas flow channel when being coupled to a keg cap of the keg; an intermediate tank provided between the undiluted solution flow channel and the gas flow channel such that the undiluted solution flow channel communicates with the gas flow channel; and a pump provided on the undiluted solution flow channel.

### TECHNICAL FIELD

The present disclosure relates to a keg cap of a keg and a keg, and more particularly a keg cap of a keg, which is detachably connected to the keg to discharge wort or gas inside the keg or to supply yeast into the keg, and a keg including the keg cap.

### BACKGROUND ART

Beer is an alcoholic drink made by making juice from malt made by sprouting barley, filtering the juice, adding hops, and fermenting the juice with hops with yeast.

This beer manufacturing method includes boiling malt to produce wort, supplying yeast to the work to ferment the wort, and aging the fermented beer, and beer sold in supermarkets and marts is manufactured by sterilizing the beer produced using the above method for distribution and storage and then being bottled or canned.

However, since yeast is killed when the aged beer is sterilized, currently distributed beers are beers in which the yeast is killed during the sterilization process.

On the other hand, craft beer is a beer in which yeast is alive, and refers to a unique beer produced directly to enhance the taste and aroma of beer. Such craft beer is only tasted in special places with brewing production facilities, and it is possible to make more than 100,000 different types of craft beer depending on which yeast and hops are added.

However, craft beer is only made through complex and diverse manufacturing processes. In particular, huge equipment investment, long manufacturing time, and a lot of labor are required in the fermentation and maturation process, which corresponds to an inefficient manufacturing system that requires professional personnel to directly manage the entire manufacturing process.

For fermentation after wort production, a process of transferring the wort contained in a wort container to a fermenter is required. In this case, since the quality of beer may be degraded because of contamination and oxygen contact due to external contact, all contact surfaces and flow paths need to be washed and sterilized such that there are no other germs, and accordingly, there is a problem in that a lot of time and labor are required.

That is, conventionally, enormous investment in facilities, equipment, and manpower are required to manufacture craft beer, and in this case, even when craft beer is manufactured with a small scale, hundreds of millions of investments in equipment and a large number of manpower need to be employed. In particular, there is a problem in that specialized knowledge or expertise in craft beer brewing are required.

In a conventional beer manufacturing apparatus, a large amount of beer is produced by fermenting a large amount of beer in one tank by making a large amount of wort at once. However, in this process, if even beer is slightly contaminated, the entire beer is contaminated and is not usable or when beer is not sold, beer needs to be stored for a long period of time and the quality of beer is degraded.

In order to resolve this problem, Korean Patent Application No. 10-2017-0119868 (hereinafter referred to as “Cited Reference”) discloses a beer manufacturing device for producing an appropriate amount of craft beer and various kinds of craft beer.

However, in the Cited Reference, when a coupler of the beer manufacturing apparatus is fastened to a keg cap of a keg, a gas discharge flow path is sealed and opened and closed by a sealing member. The sealing member of the Cited Reference is elastically pressed by a spring, etc., and since such a sealing member has a relatively small cross-sectional area, it may be difficult to accurately move the sealing member up and down vertically when moving up and down by the spring or the like.

Therefore, the beer production apparatus according to the Cited Reference has a problem in that the gas discharge flow path of the keg cap is not accurately sealed or closed before fastening the coupler.

In addition, in the case of the Cited Reference, the sealing member does not accurately move up and down even after the coupler is fastened to the keg cap, and thus there is a problem in that the gas discharge flow path is not completely open and gas is not smoothly discharged.

Therefore, there is a need for a method for resolving the problems in a field of the conventional craft beer and the problems in the Cited Reference.

Beer is a fermented beverage, and alcohol such as wine or makgeolli is also a fermented beverage. That is, besides a difference that basic raw materials are barley, grapes, and rice, manufacturing methods of beer, wine, and makgeolli may be similar. In addition, the manufacturing method of fermented beverages such as kombucha, which is made by fermentation after adding symbiotic colony of bacteria & yeast (SCOBY) beneficial bacteria to an undiluted solution of green or black tea steeped in water and sugar, may be similar to the above manufacturing methods. Like beer, fermented beverages such as wine, makgeolli, and kombucha are not uniformly manufactured, but need to be manufactured in a variety of ways according to the tastes and preferences of consumers or manufacturers.

Therefore, it is necessary to provide an apparatus and control method for producing a fermented beverage through fermentation of an undiluted solution regardless of a type of fermented beverages further from beer.

### DISCLOSURE

### Technical Problem

The present disclosure is to resolve conventional problems.

An embodiment of the present disclosure provides a keg cap and a keg including the same, which accurately open and close a gas discharge flow path when the keg cap is connected to a coupler of a fermented beverage manufacturing apparatus.

An embodiment of the present disclosure provides a keg cap and a keg including the same, which reliably and independently separate a flow path which is connected to a coupler and through which gas moves through the inside of the keg cap and a flow path through which a fermented beverage or an undiluted solution moves.

An embodiment of the present disclosure provides a keg cap and a keg including the same, in which an additive capsule such as a yeast capsule is integrally formed on the keg cap. As such, it is possible to reduce user effort for installing the additive capsule, and to provide a simple flow path structure by omitting the additional configuration for flow path conversion.

### Technical Solution

To achieve the aforementioned objectives, according to an embodiment of the present disclosure, a keg cap includes a cap body connected to a keg, and a cap moving member movable up and down inside the cap body, opening and closing a gas discharge flow path through which gas inside the keg moves, and providing an undiluted solution discharge flow path in which an undiluted solution moves.

The cap moving member may move up and down as the cap body is coupled to the coupler of a fermented beverage manufacturing apparatus. The cap moving member may be moved to a bottom when coupled to the coupler, and may be moved to a top when uncoupled to the coupler.

Here, the gas discharge flow path may be formed between an inner wall of the cap body and an outer wall of the cap moving member.

The cap moving member may further include a first sealing member sealing the gas discharge flow path.

A connector connected to the first sealing member may be further provided on an outer wall of the cap moving member.

The connector may be provided on the outer wall of the cap moving member at a predetermined interval, and may slidably contact the inner wall of the cap body.

A first elastic member provided inside the cap body to support the cap moving member may be further provided.

The cap body may include a cap upper body connected to an opening of the keg, and a cap lower body connected to a lower part of the cap upper body to support the first elastic member.

A capsule may be accommodated inside the cap moving member. The capsule may be provided to be detachable inside the cap moving member, but when manufacturing the cap, the capsule may be mounted on the inside such that the cap and the capsule are processed as an integral structure. In the latter case, a user may not need to attach or remove the capsule to or from the cap.

When the capsule is provided inside the cap, additives such as yeast may be sealed inside the capsule. Therefore, when the cap is coupled to the coupler, the seal needs to be released.

To this end, the keg cap may include a cap blade part and a capsule support.

The cap plate portion may be provided inside the cap moving member to break a lower sealing part of the capsule.

The capsule support may include a second sealing member provided to support a lower end part of the capsule inside the cap moving member and to be movable up and down, and to open and close the undiluted solution discharge flow path of the cap moving member.

The capsule support may be elastically supported by a second elastic member provided in a lower part of an inside of the cap moving member, and thus when the capsule is pressed downward (by coupling with the coupler), the capsule support descends, the lower sealing part of the capsule is broken by the cap blade part, and the undiluted solution discharge flow path may be open.

The cap body may further include a guide part, and the guide part may include an inclined part guiding movement of the hook part of the coupler when the coupler is connected, and a staircase to which the hook part is fastened.

To achieve the aforementioned objectives, an embodiment of the present disclosure may provide a keg cap coupled to a coupler of a flow path module for preparing a fermented beverage through an undiluted solution and included in a keg accommodating the undiluted solution.

A keg cap provided in a keg accommodating the undiluted solution includes a cap body connected to the keg, and a cap moving member movable up and down inside the cap body to open and close a gas discharge flow path through which the gas inside the keg moves, and configured to provide an undiluted solution discharge flow path through which an undiluted solution moves, wherein, when the coupler is coupled to the keg cap, the gas discharge flow path communicates with the gas flow path of the flow path module, and the undiluted solution discharge flow path communicates with the undiluted solution flow path of the flow path module.

The keg cap may be an integral keg cap in which a capsule containing yeast is embedded. That is, the capsule may be embedded inside the cap moving member.

When the keg cap is mounted on the coupler, the inside of the capsule may constitute a part of the undiluted solution discharge flow path.

To achieve the above objectives, according to an embodiment of the present disclosure, a keg cap coupled to a coupler of a flow path module for producing a fermented beverage through an undiluted solution and provided in a keg accommodating the undiluted solution includes a cap body connected to the keg, a cap moving member formed in a cylindrical shape having a hollow constituting an undiluted solution discharge flow path and moving downward by being pressurized when the cap body is coupled to the coupler, and a first sealing member provided on an upper part of the cap moving member and moving downward together with the cap moving member to open a gas discharge flow path formed between an inner side of the cap body and an outer side of the cap moving member, wherein, when combined with the coupler, an upper end part of the cap moving member is pressurized by the sealing member of the coupler to block communication between the undiluted solution discharge flow path and the gas discharge flow path through the upper end part of the cap moving member.

That is, a radially outer side of the cap moving member may define a gas discharge flow path and a radially inner side may define form an undiluted solution discharge flow path.

The cap moving member may include a cylindrical body having a hollow; a fastener having a hollow smaller than the hollow of the body at a lower center of the body and having an outer diameter smaller than that of the body, and a pressure valve provided to be pressurized and moved downward when coupled to the coupler and open the undiluted solution discharge flow path.

The cap moving member may move downward with respect to the cap body, and the pressure valve may move downward together with the cap moving member and may further move downward with respect to the cap moving member.

The body and the fastener are integrally formed, and when coupled to the coupler, a downward displacement of the pressure valve is greater than a downward displacement of the body and the fastener. This may be implemented by providing the pressure valve to move downward with respect to the cap moving member.

A capsule accommodating yeast may be accommodated in the hollow of the body of the cap moving member.

When coupled to the coupler, an upper end of the capsule is pressurized downward by the coupler, and a lower end of the capsule pressurizes the body of the pressure valve downward, and thus the pressure valve may be moved downward. That is, the coupler may be provided to press the cap moving member downward while separately pressing the capsule downward at the same time.

The cap moving member may include a plurality of cap blades protruding upward into the hollow of the body at predetermined intervals in a circumferential direction from an upper part of the fastener.

The pressure valve may include the body, a communication hole that is formed in the body and through which the cap blade passes, an extension support extending downward from the center of the body, and a sealing member provided in the extension support and provided to open a hollow of the fastener when contact with the fastener is released.

The pressure valve may be elastically supported with respect to the cap moving member and may be movable downward. The pressure valve may be provided to support the capsule. When pressurizing the capsule downward through the coupler, the pressure valve supports the capsule at a bottom of the capsule such that the cap blade may penetrate the lower sealing part at the bottom of the capsule. Therefore, the pressure valve may be a component supporting the capsule as well as opening the undiluted solution discharge flow path. Therefore, the pressure valve may also be called a capsule support.

The objectives of the present disclosure as described above may be achieved by the keg having the aforementioned keg cap.

Features in the above-described embodiments may be applied in combination in other embodiments as long as they are not contradictory or exclusive.

### Advantageous Effects

An embodiment of the present disclosure provides a fermented beverage manufacturing apparatus and manufacturing method for independently manufacturing and independently cleaning a plurality of fermented beverages.

An embodiment of the present disclosure provides a fermented beverage manufacturing apparatus and manufacturing method for smoothly performing movement of an undiluted solution and gas in a manufacturing process of fermented beverage, improving the durability of a pump driven for movement of the undiluted solution and accurately controlling flow.

An embodiment of the present disclosure provides a fermented beverage manufacturing apparatus and manufacturing method for effectively cleaning a flow module in which an undiluted solution and gas are moved during a manufacturing process of fermented beverage.

An embodiment of the present disclosure provides a fermented beverage manufacturing apparatus and manufacturing method for relatively increasing the manufacturing capacity of fermented beverages by dispensing a plurality of fermented beverages through a single cock to ensure the convenience of dispensing and simplifying a dispensing structure.

An embodiment of the present disclosure provides a fermented beverage manufacturing apparatus and manufacturing method for effectively excluding mixing and dispensing of different types of fermented beverages even when a plurality of fermented beverages are dispensed with a single cock.

An embodiment of the present disclosure provides a fermented beverage manufacturing apparatus and manufacturing method for effectively and easily cleaning not only the flow module but also the entire path until fermented beverage is moved and dispensed.

An embodiment of the present disclosure provides a fermented beverage manufacturing apparatus and manufacturing method for flexibly coping with various usage scenarios by vertically forming chambers in a circumferential direction of a rotatable case, dispensing fermented beverage through a specific upper chamber (dispensing chamber), and arranging common components of a lower chamber (common chamber) of the dispensing chamber.

An embodiment of the present disclosure provides a fermented beverage manufacturing apparatus that is to be purchased and used easily like home appliances at home or in a business, and a manufacturing method of the apparatus. In particular, the embodiment of the present disclosure provides a fermented beverage manufacturing apparatus and manufacturing method for producing different fermented beverages at the same time and dispensing each of the manufactured fermented beverages.

An embodiment of the present disclosure provides a fermented beverage manufacturing apparatus for minimizing an installation space and improving manufacturing and durability.

An embodiment of the present disclosure provides a fermented beverage manufacturing apparatus for simplifying a cold air supply structure by applying a cell structure such that a plurality of chambers are implemented through each cell structure and cold air is supplied through a space surrounded by cell structures.

### DESCRIPTION OF DRAWINGS

FIG. 1 is a perspective view showing a fermented beverage manufacturing apparatus according to an embodiment of the present disclosure.

FIG. 2 is a perspective view showing an internal configuration of a machine room of FIG. 1.

FIG. 3 is an exploded perspective view showing a cell case defining a chamber.

FIG. 4 is a plan view showing an inside of a machine room of the fermented beverage manufacturing apparatus.

FIG. 5 is a side view illustrating a cold air supply unit.

FIG. 6 is a diagram schematically illustrating a horizontal cross section of a fermented beverage manufacturing apparatus.

FIG. 7 is a view showing a state in which a keg cap assembly is mounted on a keg.

FIG. 8 is a view showing a cap cover and a fixing gasket.

FIG. 9 is a view showing a keg cap and an undiluted solution hose.

FIG. 10 is a cross-sectional view of a keg cap.

FIG. 11 is an exploded side view of a keg cap.

FIG. 12 is a view showing a cap upper body.

FIG. 13 is a view showing a cap lower body.

FIG. 14 shows a cap moving member disposed inside a cap body.

FIG. 15 is a view showing a capsule.

FIG. 16 is a diagram showing a capsule support

FIG. 17 is a perspective view of a coupler.

FIG. 18 is an exploded perspective view of a coupler.

FIG. 19 is a side cross-sectional view of a coupler.

FIG. 20 is a view showing a coupler body.

FIG. 21 is a view showing a coupler moving member.

FIG. 22 is a side cross-sectional view showing a situation before connecting a coupler to a keg cap.

FIG. 23 is a side cross-sectional view showing a situation in which a coupler is connected to a keg cap.

FIG. 24 is an enlarged view of an area ‘A’ in FIG. 23.

FIG. 25 is an enlarged view of an area ‘C’ in FIG. 23.

FIG. 26 is an enlarged view of an area ‘B’ in FIG. 23.

### BEST MODE

Hereinafter, a fermented beverage manufacturing apparatus according to an embodiment of the present disclosure will be described with reference to the accompanying drawings.

The fermented beverage described herein is prepared by fermenting an undiluted solution such as wort, such as beer or makgeolli. In this specification, for convenience, beer is assumed as an example of the fermented beverage. Terms based on beer are explained, but the present embodiment is not limited to beer, which is an example of the fermented beverage.

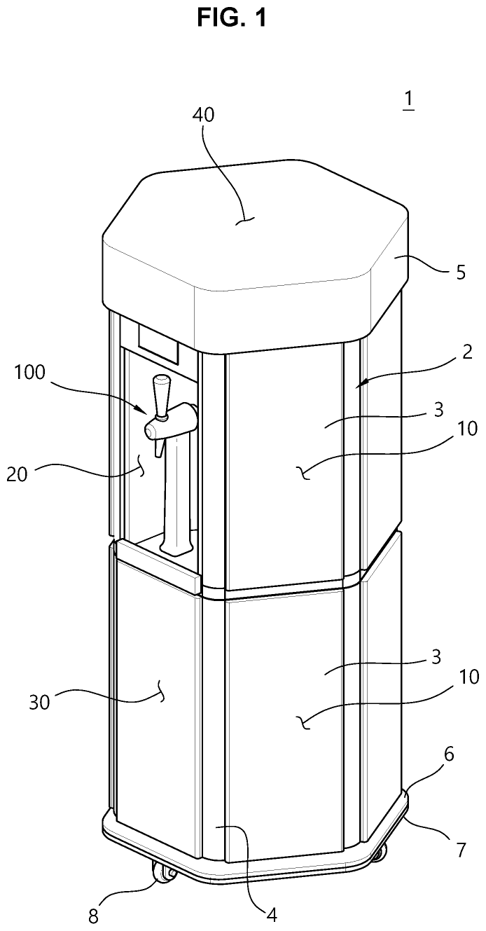

FIG. 1 is a perspective view showing a fermented beverage manufacturing apparatus 1 according to the present embodiment.

Referring to FIG. 1, the fermented beverage manufacturing apparatus 1 may include a case 2 and a plurality of doors 10 defining an external shape.

The case 2 may include a machine room housing 5. The machine room housing 5 may be located above the fermented beverage manufacturing apparatus 1. That is, the machine room housing 5 may be provided to define a machine room and protect components inside the machine room from the outside.

The fermented beverage manufacturing apparatus 1 may include a plurality of cells. The cells may each include a chamber, and may be distinguished from each other according to a function of the chamber, and may be classified into a keg cell, a dispensing cell, and a common cell. Each cell may constitute a part of the case 2. That is, a plurality of cells may be connected to form a support structure of a fermented beverage manufacturing apparatus.

A container that accommodates the undiluted solution of a fermented beverage may be called a keg 80. The undiluted solution of a fermented beverage becomes a fermented beverage through the manufacturing process, and the fermented beverage may also be accommodated in the same keg 80.

In this case, a chamber including the keg 80 may be referred to as a keg chamber 10. A fermented beverage may be prepared and stored from an undiluted solution through the keg 80 provided inside the keg chamber 10. The keg chamber 10 may be provided in plurality in the case 2. Each keg chamber 10 may include a keg, and thus different types of fermented beverages may be produced. Production of fermented beverages through the keg chamber 10 may be performed independently of each other. Thus, different fermented beverages may be produced at the same time.

A chamber for dispensing the manufactured fermented beverage to the outside may be referred to as a dispensing chamber 20 or a dispenser chamber. A dispenser assembly 100 for dispensing the fermented beverage is provided inside the dispensing chamber 20.

According to the present embodiment, fermented beverages manufactured in the keg 80 of the plurality of keg chambers 10 may be dispensed through a single dispenser assembly 100. That is, a single dispensing chamber 20 may be provided. Also, the single dispenser assembly 100 may be provided in the single dispensing chamber 20, and a single cock may be provided in the single dispenser assembly 100. A selected fermented beverage among a plurality of fermented beverages may be dispensed through the single cock.

The plurality of chambers may include the keg chamber 10 and the dispensing chamber 20 as well as a common chamber 30. The common chamber 30 may be a chamber for accommodating a component for cleaning a dispenser assembly or components such as a carbon dioxide tank necessary for dispensing fermented beverages after manufacturing the fermented beverages. That is, the common chamber 30 may be a chamber that accommodates components connected to a plurality of independently provided keg chambers 10 or dispensing chambers 20.

Components for executing a cooling cycle may be provided in the above-described machine room 40. The durability of these cooling cycle configurations is sufficiently ensured. In addition, the components do not require frequent user access. Accordingly, the machine room 40 may be positioned above the fermented beverage manufacturing apparatus 1.

As shown in FIG. 1, the fermented beverage manufacturing apparatus 1 according to the present embodiment may have a hexagonal cross section. Chambers may be formed on the top and bottom of one surface of the hexagonal cross section, respectively. Since the fermented beverage manufacturing apparatus 1 has a total of 6 surfaces, a total of 12 chambers may be provided along a circumference of the fermented beverage manufacturing apparatus. The size of the cell case in which the chamber is formed may be symmetrical to each other. Therefore, the hexagon may be a regular hexagon.

Here, the 10 chambers may be the keg chamber 10, one chamber may be the dispensing chamber 20, and the remaining one may be the common chamber 30. In order to manufacture a fermented beverage with a largest capacity in a limited size of the fermented beverage manufacturing apparatus 1, a single dispensing chamber 20 and a single common chamber 30 may be formed, and the remaining chambers may be formed as keg chambers. This is because when a plurality of dispensing chambers or common chambers are provided, the number of keg chambers is reduced, resulting in a decrease in fermented beverage manufacturing capacity.

Since the keg chamber 10 is a space for manufacturing a fermented beverage, the keg chamber 10 may be a space that requires heating or cooling. Therefore, the keg chamber 10 needs to be insulated from the outside, and a door 3 is provided for this purpose. That is, a door 3 for opening and closing the chamber may be provided.

The door 3 may be formed as an insulated door, and the door 3 may be provided for each of the keg chambers 10. Through this, independent cooling and independent heating may be performed.

The common chamber 30 may be a space accommodating a carbon dioxide tank or a drain tank. These components may not be exposed to the outside. Accordingly, the door 3 for opening and closing the common chamber 30 may also be provided. The door 3 of the common chamber 30 may also be an insulated door, but may not be an insulated door since temperature control inside the chamber may be unnecessary.

The dispensing chamber 20 is a chamber for dispensing manufactured fermented beverage. Therefore, the dispensing chamber 20 is a chamber most frequently accessed by a user. In order to dispense the fermented beverage, the user needs to hold a container such as a drinking cup and insert the container into the chamber. Therefore, for ease of use, the dispensing chamber 20 may not be provided with a door.

A frequency of user access to the keg chamber 10 may be relatively very low. That is, when replacing the keg 80, a user may generally access the keg chamber 10, and it takes a relatively long time to manufacture and consume a fermented beverage in the installed keg 80.

On the other hand, the frequency of user access to the common chamber 30 may be greater than that of the keg chamber 10 and less than that of the dispensing chamber 20. This is because a frequency of management of common components, such as replacement of a carbon dioxide tank or cleaning of a drain tank, may be relatively high. Therefore, it may be possible to implement an optimized chamber arrangement according to a frequency of use of the user by forming the common chamber 30 under the dispensing chamber 20. This is because the dispensing chamber 20 and the common chamber 30 may be exposed in front of a path of the user according to this configuration.

As a result, in consideration of a frequency of access to the chambers and an approach posture of the user, the dispensing chamber 20 may be positioned above the common chamber 30. That is, it may be very easy to dispense the fermented beverage by positioning the dispenser assembly 100 according to an average height of the user.

Unlike the above description, the machine room may be positioned below the chambers. However, in this case, since the height of the dispenser assembly 100 is inevitably increased, it may not be easy to dispense the fermented beverage. In addition, the inside of the machine room is formed as an empty space, and cooling cycle components are provided therein. Therefore, it is not desirable to allow the machine room itself to support vertical load.

Needless to say, a machine room chamber may be formed similarly to the common chamber. However, in this case, there is a problem in that the capacity for producing fermented beverages is reduced because the number of keg chambers 10 is inevitably reduced. In addition, it is not easy to configure a cooling cycle by accommodating components such as a compressor, a condenser, and a condenser fan in a small space. Therefore, the machine room may be located above the chambers, that is, on top of the fermented beverage manufacturing apparatus.

When the positions of the dispensing chamber 20 and the common chamber 30 are fixed to a front surface of the case 2, access to the keg chamber 10 may not be easy. For example, in order to access the keg chamber 10 located behind the dispensing chamber 20, a user needs to move to a rear surface of the fermented beverage manufacturing apparatus 1. In this case, a space accessible to the user through an entire circumference of the fermented beverage manufacturing apparatus 1 is required. That is, an excessively large installation space is required.

In order to resolve this problem, in the present embodiment, the fermented beverage manufacturing apparatus 1 may be provided to be rotatable with respect to the ground. In this case, even if an access space of the user is ensured only in front of the fermented beverage manufacturing apparatus 1, it may be sufficient to install the fermented beverage manufacturing apparatus 1. This is because when a user approaches a specific keg chamber, the fermented beverage manufacturing apparatus 1 may be rotated to position a specific keg chamber in front of the user. Therefore, a relatively small installation space is required. In other words, only a space accessible to the user from a front side like in a refrigerator may be required.

The fermented beverage manufacturing apparatus 1 may be relatively heavy and may include a caster 8 to facilitate horizontal movement. The caster 8 may be combined with a bottom frame 7.

A lower cell frame 6 may be provided above the bottom frame 7. The lower cell frame 6 may be formed to face the bottom frame 7. A circular thrust bearing (not shown) may be provided between the bottom frame 7 and the lower cell frame 6. That is, vertical load transmitted through the lower cell frame 6 is rotatably supported by the thrust bearing. The lower cell frame 6 and the bottom frame 7 are spaced apart from each other in upward and downward directions by bearings.

Accordingly, the lower cell frame 6 may rotate while the bottom frame 7 is fixed. This rotation means that the fermented beverage manufacturing apparatus 1 excluding the bottom frame 7 and the caster 8 is capable of rotating horizontally. Therefore, it is not necessary to ensure an extra installation space, and thus usability may be increased. This is because the user is capable of accessing all chambers in one direction by rotating the fermented beverage manufacturing apparatus.

Since the entire machine room as well as the plurality of chambers rotates together, additional components for rotation between the machine room and the chambers are not required. Specifically, there is no need for configurations to allow relative rotation between the machine room and chambers while supporting vertical load. This is because the fermented beverage manufacturing apparatus 1 excluding the bottom frame 7 may be rotated as a whole and integrally.

Therefore, a very effective and compact cooling air supply structure may be provided. In addition, the detailed configuration of the case 2 constituting the structure of the fermented beverage manufacturing apparatus 1 may be manufactured very simply.

The case 2 may include decoration panels 4 provided at a corner portion. Chambers may be provided vertically with both the decoration panels 4 therebetween. The decoration panels 4 may be provided to support vertical load and lateral external force. In addition, the decoration panels 4 may provide a beautiful design by forming a portion exposed to the outside at a corner portion of the fermented beverage manufacturing apparatus 1.

However, the fermented beverage manufacturing apparatus 1 according to the present embodiment may apply the independent cell structures as described above and may support vertical load and lateral external force by itself due to engagement between cells. That is, vertical engagement may be formed between cells, and circumferential engagement may be performed between the cells, and thus structurally very stable manufacturing may be achieved. In other words, the decoration panels 4 supporting the vertical load and lateral external force are unnecessary, and the decoration panel in terms of design may be provided.

When the decoration panels 4 perform a function of a pillar supporting vertical load, the decoration panels 4 may be made of a metal material. Needless to say, the decoration panels 4 may also be thick enough to support vertical load.

On the other hand, when the decoration panels 4 perform a decorative function provided at corners, the decoration panels 4 may be made thin enough and made of synthetic resin or wood instead of metal. Therefore, effects such as reduction in manufacturing cost, ease of manufacture, and weight reduction may be obtained.

Hereinafter, with reference to the drawing, the case 2 and cooling cycle configuration of the fermented beverage manufacturing apparatus 1 will be described in more detail.

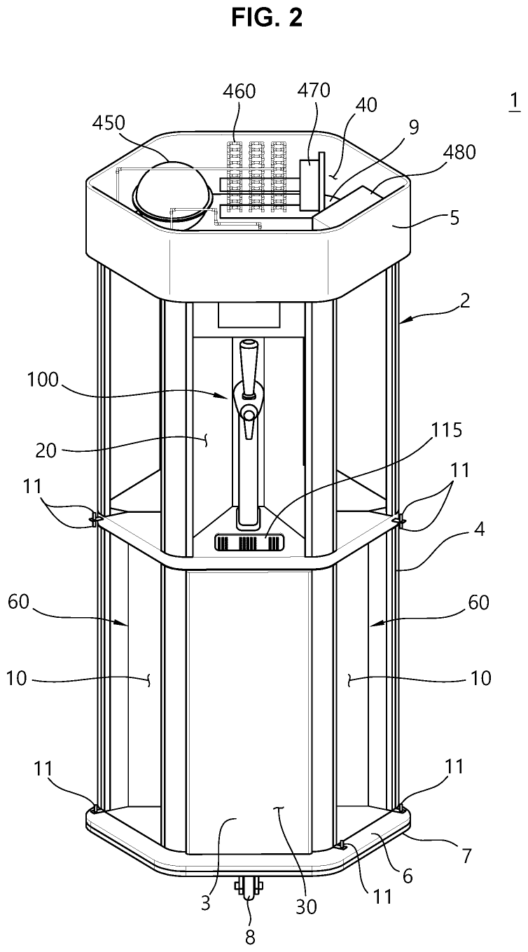

FIG. 2 is a perspective view showing the internal configuration of the machine room 40 shown in FIG. 1.

As shown in FIG. 2, the case 2 may include the lower cell frame 6 and an upper cell frame 9. Since the fermented beverage manufacturing apparatus 1 has a hexagonal cross section, the lower cell frame 6 and the upper cell frame 9 may also have hexagonal shapes corresponding thereto.

The decoration panel 4 may be provided at each corner of the hexagon. The decoration panel 4 may be divided into upper and lower parts and connected to each other. That is, an upper end of the upper decoration panel 4 may be combined with the upper cell frame 9, and a lower end of the lower decoration panels 4 may be combined with the lower cell frame 6. The upper end of the upper decoration panel 4 and the upper end of the lower decoration panel 4 may be combined together.

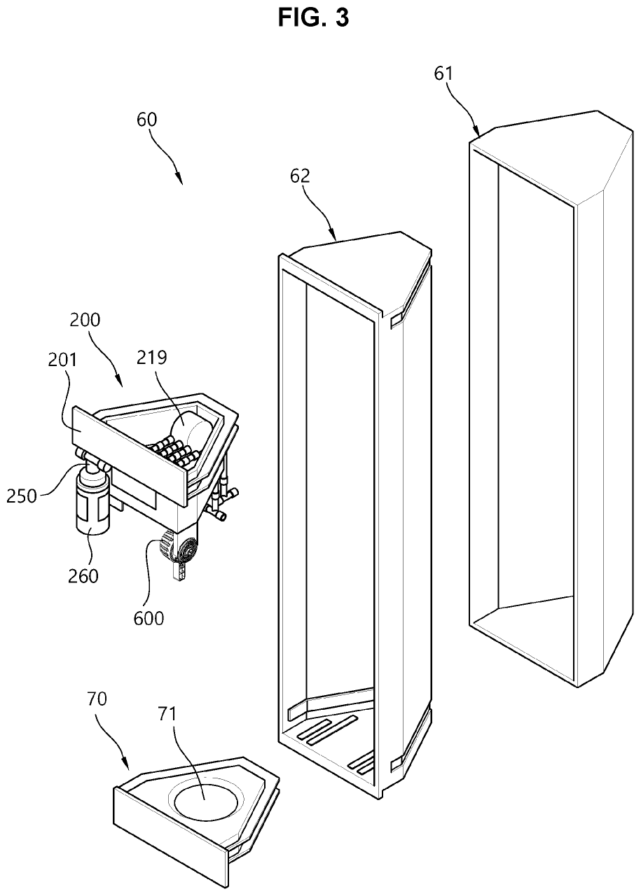

FIG. 3 shows a cell case 60 defining the aforementioned chamber, and in particular, a cell case 60 defining the keg chamber 10. A cell case defining a dispenser chamber 20 or a common chamber 30 may be the same or similar to the cell case shown in the drawing.

The cell case 60 may be defined by including an outer cell case 61 and an inner cell case 62. Both the outer cell case 61 and the inner cell case 62 have an open front shape. The inner cell case 62 may be inserted into the front opening of the outer cell case 61 to integrally form the cell case 60.

The inner cell case 62 may be formed through injection or vacuum molding. That is, the inner cell case 62 may be formed of a synthetic resin material. Since the inner cell case 62 forms a chamber, the inner cell case 62 may be formed of a synthetic resin material to improve texture and ease of cleaning.

The outer cell case 61 may be manufactured using a steel plate. The outer cell case 61 forms a structure in which a top surface, a bottom surface, and side surfaces are all connected except for the front opening. That is, the outer cell case 61 itself may support vertical and horizontal loads as a single block.

The inner cell case 62 may be inserted into the outer cell case 61 and integrally formed through a foaming process. That is, the cell case 60 forms a single configuration. The foam between the inner cell case 62 and the outer cell case 61 serves to improve insulation performance. Therefore, the cell case 60 may be combined with the above-described insulated door 3 to form a chamber, which is an internal space, as an insulation space.

When the cell case 60 forms the aforementioned keg chamber 10, a keg supporter 70 and a flow module 200 may be provided inside the inner cell case 62.

The keg supporter 70 may include a keg accommodation part 71 on which the keg 80 is accommodated.

The flow module 200 is mounted on the inside of the inner cell case 62, and the medium tank 260 may also be mounted. The medium tank 260 may be a part of the flow module 200.

In addition, the flow module 200 may include the coupler 270 provided to couple with a cap 520 of the keg 80.

The flow module 200 may include various components such as a pump, a plurality of fittings, a plurality of tubes, and a plurality of valves. However, the flow module may be manufactured and installed as a single module, and may be formed as a compact module.

Through the rear wall of the inner cell case 62 described above, cold air may be introduced and discharged. Accordingly, the inlet/outlet of air may be shielded from being exposed to the user. In addition, some components of the flow module 200 provided on top of the inner cell case 62 are also shielded. That is, only some components such as the coupler 270 or the medium tank 260 of the flow module 200 that need to be manipulated by a user may be exposed inside the inner cell case 62, and the other detailed components of the flow module 200 are shielded.

In particular, a flow module case 201 constituting a flow module may be mounted above the inner cell case 62, and the pump 219 and a tube may be accommodated inside the flow module case 201.

Therefore, many components of the flow module may be shielded and fixedly supported through the flow module case 201 and the back cover 90. That is, components such as the coupler 270 for coupling with the keg and the tank coupler 250 for coupling with the medium tank 260 may be exposed, and other components may be shielded.

The case 2 of the fermented beverage manufacturing apparatus 1 according to the present embodiment may include the plurality of cell cases 60. That is, the plurality of cell cases may support vertical load and horizontal load while stacking up and down and engaging in a circumferential direction. Accordingly, a component such as a cabinet for accommodating a plurality of cell cases is not required.

FIG. 2 shows an example in which a total of six cell cases 60 are mounted on a lower part of the fermented beverage manufacturing apparatus 1, and shows an example in which a cell case constituting a dispensing chamber is mounted on an upper part.

Five empty spaces may be formed in a circumferential direction in the dispensing chamber, and a total of five cell cases 60 may be inserted and mounted in these spaces.

With regard to an assembly sequence, six cell cases 60 may be mounted on the lower cell frame 6, the six cell cases may be mounted thereon again, and then an upper cell case positioned at an upper part may be combined with the lower cell frame 6. Thereafter, the machine room 40 may be formed.

At this time, the decoration panels 4 may be first coupled between the lower cell frame 6 and the upper cell frame 9, and the decoration panels 4 may be coupled after mounting the cell cases 60.

Therefore, in the fermented beverage manufacturing apparatus 1 according to the present embodiment, the case 2 defining basic appearance of the fermented beverage manufacturing apparatus 1 may be formed through the lower cell frame 6, the plurality of cell cases 60 engaged with each other, and the upper cell frame 9. Therefore, the fermented beverage manufacturing apparatus 1, which is very simple and is easily manufactured, may be manufactured. In particular, since chambers that need to have an insulating space may be implemented through the cell case 60 each independently having an insulating wall, it may be very easy and simple to ensure the insulating performance and form the insulating wall.

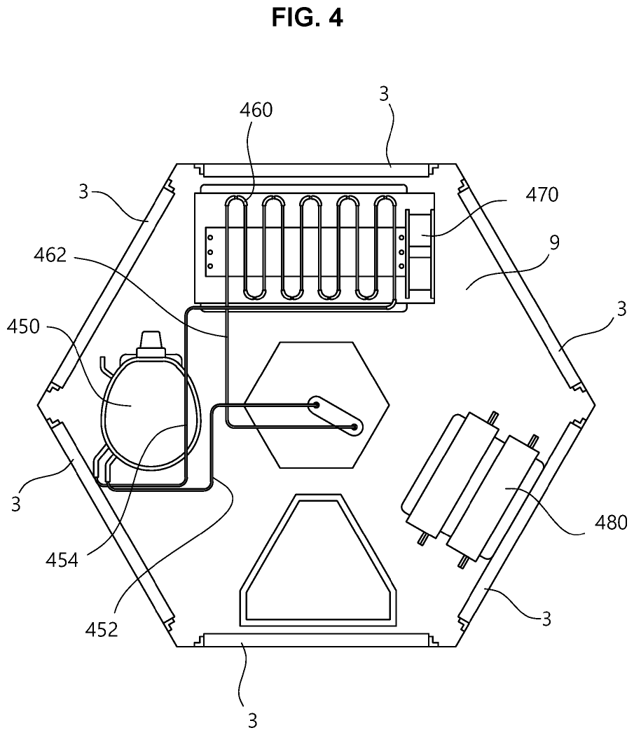

FIG. 4 is a plan view showing an inside of the aforementioned machine room 40.

Referring to FIGS. 2 and 4, most components of the cooling cycle are accommodated in the machine room 40. A side surface of the machine room 40 is shielded through the machine room housing 5, and the machine room housing 5 may be provided to shield a top surface of the machine room 40. However, the top surface of the machine room may be open to enable smooth heat exchange through the condenser.

The fermented beverage manufacturing apparatus 1 according to the present disclosure may include a cold air supply unit 400 including an evaporator module 410 respectively supplying cold air to at least some of the plurality of chambers described above.

Here, the cold air supply unit 400 may include the evaporator module 410, a compressor 450, and a condenser 460 that are provided in the case.

The compressor 450 and the condenser 460 may be provided in the machine room 40 of an upper part of the case 2 and the fermented beverage manufacturing apparatus 1 may further include a condenser fan 470 adjacent to the condenser 460. In addition, a relatively large power supply unit (SMPS) 480 may also be accommodated in the machine room 40.

The evaporator module 410 that directly supplies cold air to the keg chamber 10 described above may not be located in the machine room 40. This is because there is a risk of loss of cold air since a separation distance between the machine room 40 and each chamber is relatively large. Accordingly, the evaporator module 410 may be substantially located in an empty space 50 in the center of the fermented beverage manufacturing apparatus 1.

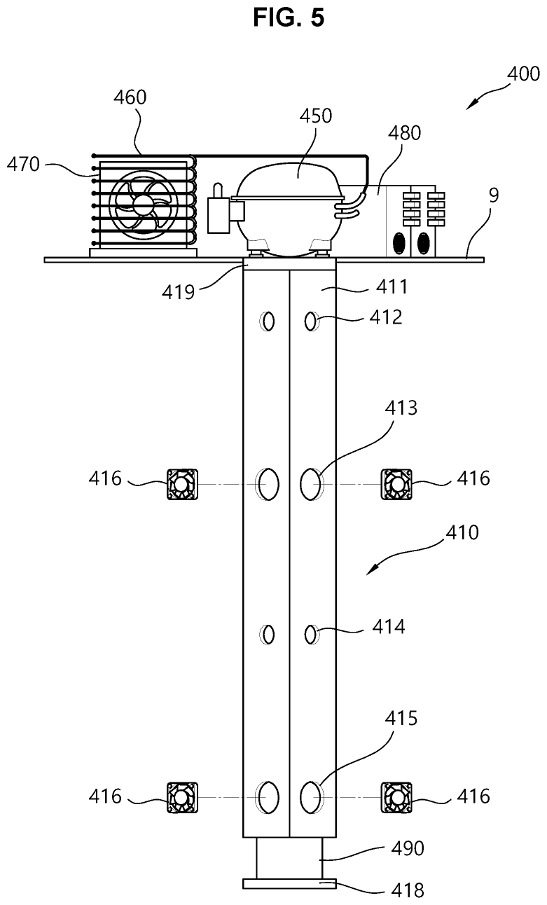

FIG. 5 is a side view illustrating the compressor 450, the condenser 460, the condenser fan 470, and the evaporator module 410, which are disposed inside the machine room 40 described above.

Referring to FIG. 5, the evaporator module 410 extends vertically in a central portion of the plurality of chambers and includes a duct 411 having communication holes 412, 413, 414, and 415 communicating with the chambers, a fan 416 provided on at least some of the communication holes 412, 413, 414, and 415 to supply cold air inside the duct 411 to the chamber, an evaporator unit (not shown) provided inside the duct 411 to supply cold air through heat exchange between refrigerants, and a defrost water tank 490 provided below the duct 411 to collect defrost water generated by the evaporator unit.

In the present embodiment, the evaporator module 410 may be configured as a single module by arranging all components in the duct 411 described above. Therefore, the evaporator module 410 may be easily installed and may be conveniently maintained by connecting the duct 411 to the upper cell frame 9.

The duct 411 may be formed to extend vertically by a predetermined length. An upper end plate 419 and a lower end plate 418 may be provided above and below the duct 411, respectively. In this case, the upper end plate 419 and the lower end plate 418 may be formed in a hexagonal shape and matched to the empty space 50 in the center of the fermented beverage manufacturing apparatus 1.

An evaporator unit is disposed inside the duct 411 to provide cold air through heat exchange of the refrigerant.

Cold air generated in the evaporator unit may be supplied to the aforementioned chamber through the communication holes 412, 413, 414, and 415 of the duct 411.

In this case, the communication holes 412, 413, 414, and 415 may include supply holes 413 and 415 for supplying cold air to the chamber and exhaust holes 412 and 414 for discharging air from the chamber to the duct 411. That is, the supply holes 413 and 415 and the exhaust holes 412 and 414 may be provided to smoothly supply cold air to the chamber from the duct 411 and to simultaneously discharge heated air in the chamber to the duct 411.

As described above, the chambers are stacked vertically and arranged in two layers. Accordingly, the supply holes 413 and 415 and the exhaust holes 412 and 414 may also be formed vertically on the duct 411 as shown in FIG. 5.

In this case, the supply holes 413 and 415 may have a relatively larger diameter than the exhaust holes 412 and 414. This is to supply the cold air inside the duct 411 to the chamber more quickly and smoothly. The fan 416 described above is provided in the supply holes 413 and 415 to quickly and smoothly supply cold air inside the duct 411 to the chamber by driving the fan 416. Although it is shown that the exhaust holes 412 and 414 do not have a fan, the present disclosure is not limited thereto, and a fan may also be provided to the exhaust holes 412 and 414 for rapid circulation of air.

Furthermore, the duct 411 may have a hexagonal cross section. Accordingly, the duct 411 may correspond to a hexagonal cross-sectional shape of the empty space 50 in the center of the fermented beverage manufacturing apparatus 1 described above. In this case, the above-described supply holes 413 and 415 and the exhaust holes 412 and 414 may be formed on surfaces of the hexagonal surface of the duct 411, respectively. In addition, the supply holes 413 and 415 and the exhaust holes 412 and 414 may be respectively formed on the upper and lower parts of the hexagonal faces of the duct 411.

The defrost water tank 490 may be provided below the duct 411. When an evaporator unit through which refrigerant flows is disposed inside the duct 411, frost may be generated in the evaporator unit, and when such frost is removed through a defrost mode, defrost water may be generated. When such defrost water falls from the evaporator unit and accumulates in an inner lower part of the duct 411, contamination and odor may be caused.

Therefore, the defrost water falling from the evaporator unit may be effectively collected in the defrost water tank 490 by providing the defrost water tank 490 at a lower part of the duct 411 and connecting the inner lower part of the duct 411 and the defrost water tank 490 through a connection hole or a connection flow path.

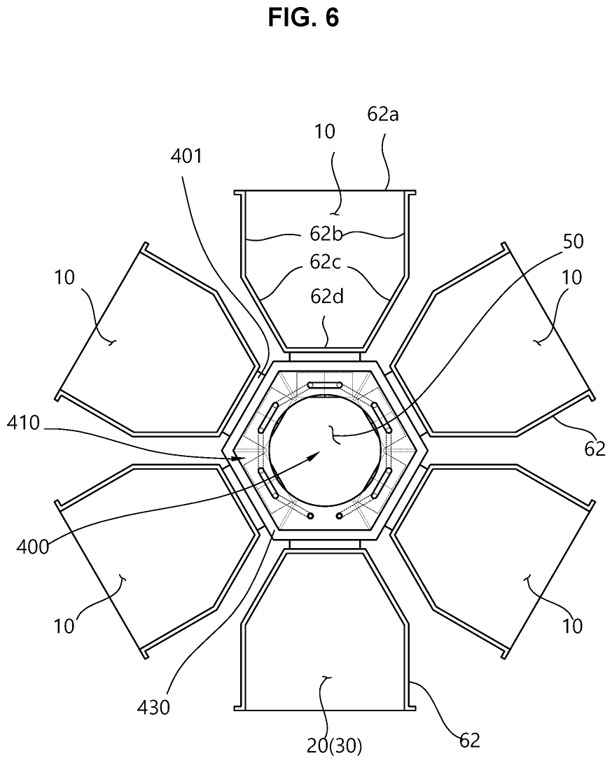

FIG. 6 is a diagram schematically illustrating a horizontal cross section of the fermented beverage manufacturing apparatus 1.

Referring to FIG. 6, the above-described cell case 60 is closely attached along a circumference of the fermented beverage manufacturing apparatus 1. In the illustrated cell case 60, the inner cell cases 62 defining a chamber are spaced apart from each other. However, the side surfaces of the cell case 60 may come into close contact with each other through the outer cell case 61.

The cell case 60 may be formed in a shape with a wide front and a narrow rear. In order to ensure an access space, left and right widths are constant up to a certain depth from the front to the rear but may become narrow backward. That is, the cell case 60 may have an approximately trapezoidal cross section.

Due to the shape of the cell case 60, the sidewall of the cell case 60 may be engaged with the sidewall of the adjacent cell case 60. In addition, the cell case 60 may be formed to sufficiently support vertical load in the form of a single block.

As described above, when the side walls of the cell case 60 are engaged with each other along the circumference of the fermented beverage manufacturing apparatus 1 (along the circumferential direction), the empty space 50 is formed at the rear of the cell case 60.

When the front surfaces of the cell case 60 form a hexagon shape and the rear surfaces of the cell case 60 are parallel to the front surface, a hexagonal space 50 is formed in the center of the fermented beverage manufacturing apparatus 1 as well. This space 50 has a hexagonal column shape.

In the present embodiment, the evaporator module 410 may be disposed using the empty space 50 in the middle of the fermented beverage manufacturing apparatus 1.

That is, cold air may be supplied to each chamber through the duct 411 surrounded by an insulation material and the evaporator unit installed vertically in the duct 411. Here, it may be possible to simultaneously implement a duct function and an insulation wall function through a hollow insulation column with a hexagonal cross section without using a general metal duct. Therefore, the duct 411 may be a heat insulating wall column in which an evaporator is accommodated.

Side walls of each cell case 60 are engaged with each other, and rear walls of the cell case 60 are engaged with the duct 411. Therefore, the empty space 50 may be automatically formed through the shape and engagement of the cell cases without a need to separately form a space for installing the duct 411.

Here, since the empty space 50 is formed at the center (or the center of a plurality of radially arranged chambers) of the fermented beverage manufacturing apparatus 1, cold air supply and cold air recovery may be performed smoothly and efficiently in a radial direction. In particular, since a flow of air to the outside of the empty space 50 may be separately excluded, loss of cold air may be minimized. This is because the duct 411 itself is formed of an insulating material and at the same time surrounds the duct with the cell cases 60 having an insulating wall.

The keg chamber 10 is formed by the cell case 60 and an inner wall of the keg chamber 10 is formed by the inner cell case 62.

A front opening 62a is formed in the inner cell case 62, and side walls 62b and 62c are formed on both sides behind the front opening 62a. Both sides of a front sidewall 62b may be formed to be substantially parallel to form a wide entrance through a front opening 62b. On the other hand, a width between both sides of a rear sidewall 62c may be reduced backward. That is, a trapezoidal space that becomes narrower backward may be formed inside the inner cell case 62 by the rear sidewall 62c.

Due to the rear sidewall 62c, the neighboring cell case 60 may come into close contact with each other in the circumferential direction.

A rear wall 62d of the inner cell case 62 is formed as a flat vertical wall, and the fan 416 is mounted on a lower part such that cold air heat-exchanged from the aforementioned evaporator unit may flow into the inner cell case 62. That is, an inlet 401 through which air is introduced may be formed in the rear wall 62d of the inner cell case 62. The inlet 401 may communicate with the supply holes 413 and 415 of the duct 411 described above.

In addition, an outlet (not shown) may be formed in the rear wall 62d of the inner cell case 62 to discharge air cooled inside the inner cell case 62 to the outside of the inner cell case 62. The outlet may communicate with the exhaust holes 412 and 414 of the duct 411 described above.

The air discharged through the outlet and the exhaust holes 412 and 414 exchanges heat with the evaporator unit, cools down, is lowered, and then flows into the inner cell case 62 through the supply holes 413 and 415 and the inlet 401. Needless to say, at this time, the fan 416 described above may be driven.

In addition, the diameter of the inlet 401 may be relatively larger than the diameter of the outlet for smooth intake and discharge of air. The shape of the inlet and outlet may be circular.

Hereinafter, the keg 80 and the keg cap 520 mounted in the keg chamber 10 of the fermented beverage manufacturing apparatus 1 according to the present disclosure will be described with reference to the drawings.

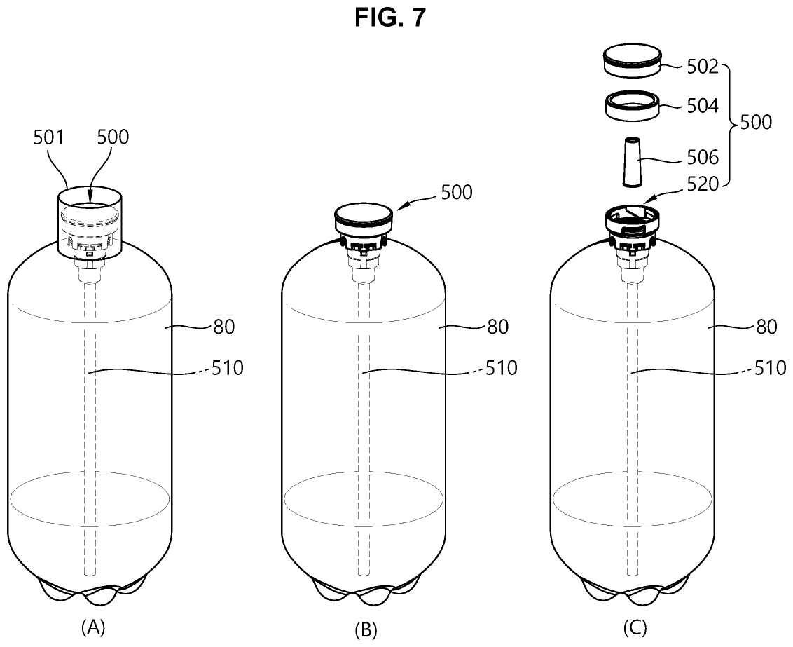

FIG. 7 is a view showing a state in which a keg cap assembly 500 is mounted on the keg 80. FIG. 7 shows a state before the keg 80 is mounted in the keg chamber 10. (A) of FIG. 7 shows a state in which the keg cap assembly 500 is surrounded by a protective film 501 and mounted on the keg 80, and (B) of FIG. 7 shows a state in which the protective film 501 is removed. (C) of FIG. 7 shows a state in which a cap cover 502, a fixing gasket 504, and a capsule 506 are separated in a state in which the keg cap 520 is mounted on the keg 80 according to the present disclosure.

Referring to FIG. 7, the keg cap 520 may be mounted on the keg 80 and may be accommodated in the keg chamber 10 and connected to a coupler 600. However, when the keg cap 520 is moved in a state of being exposed while the keg 80 moves before the keg 80 is accommodated in the keg chamber 10, the keg cap 520 may be damaged or broken during movement. In addition, when the capsule 506 containing yeast for fermenting a fermented beverage is mounted inside the keg cap 520, the capsule 506 may be lost or damaged during movement of the keg 80.

In the present disclosure, in order to prevent the above-described problem, when the keg cap 520 is connected to the keg 80 and the capsule 506 is mounted inside the keg cap 520, the cap cover 502, the fixing gasket 504, and the protective film 501 are installed to protect the keg cap 520 as described above.

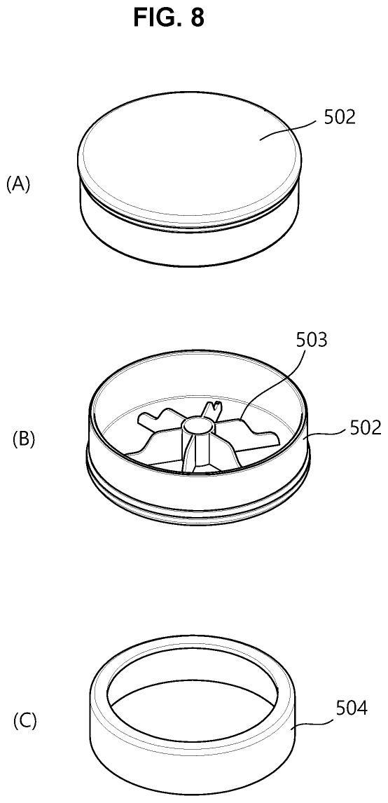

FIG. 8 shows the cap cover 502 and the fixing gasket 504. (A) of FIG. 8 is an upper perspective view of the cap cover 502, (B) of FIG. 8 is a lower perspective view of the cap cover 502, and (C) of FIG. 8 is a perspective view of the fixing gasket 504.

Referring to FIGS. 7 and 8, the capsule 506 is inserted and mounted into the keg cap 520, and the fixing gasket 504 is first mounted on the upper end part of the keg cap 520. Then, the fixing gasket 504 is covered by the cap cover 502. The cap cover 502 may be inserted into the upper portion of the fixing gasket 504 via tight fitting.

In this case, a lower end part of a protrusion rib 503 protruding downward from the inside of the cap cover 502 presses an upper end part of the capsule 506 to prevent the capsule 506 from being separated from the keg cap 520.

In addition, the cap cover 502 may be protected by inserting the above-described protective film 501 along the circumference of the cap cover 502. The protective film 501 may be made of a shrinkable material, and thus the cap cover 502 may be fixed and protected by contraction when covered with the cap cover 502.

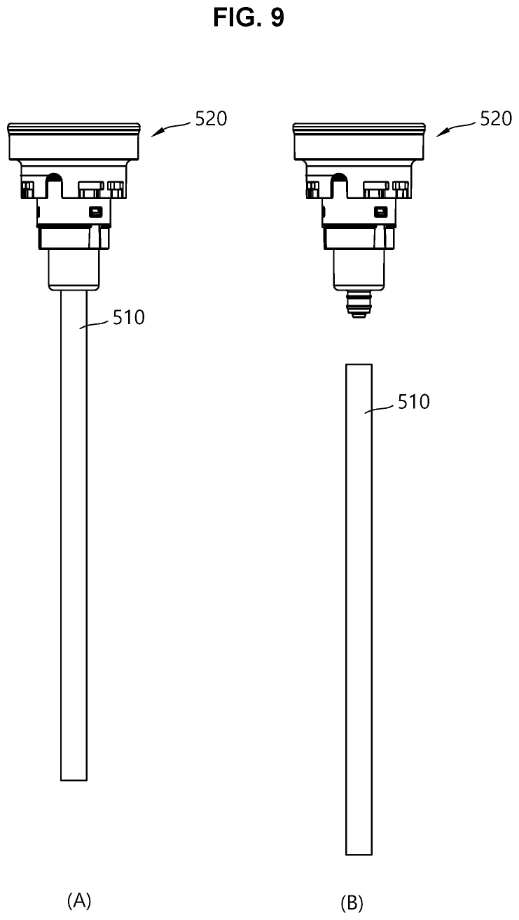

FIG. 9 shows an undiluted solution hose 510 detachably connected to the lower end part of the keg cap 520. (A) of FIG. 9 shows a state in which the undiluted solution hose 510 is connected to the keg cap 520, and (B) of FIG. 9 shows a state in which the undiluted solution hose 510 is separated.

Referring to FIGS. 7 and 9, the undiluted solution hose 510 is connected to the lower end part of the keg cap 520 and inserted into the keg 80. At this time, the length of the undiluted solution hose 510 may be determined to become a state in which a lower end part of the undiluted solution hose 510 is very close to an inner bottom of the keg 80. In this case, the undiluted solution or beer inside the keg 80 may be efficiently discharged by the undiluted solution hose 510.

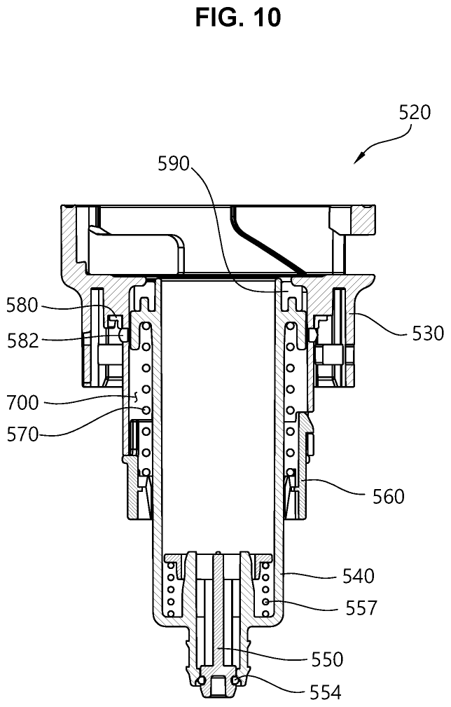

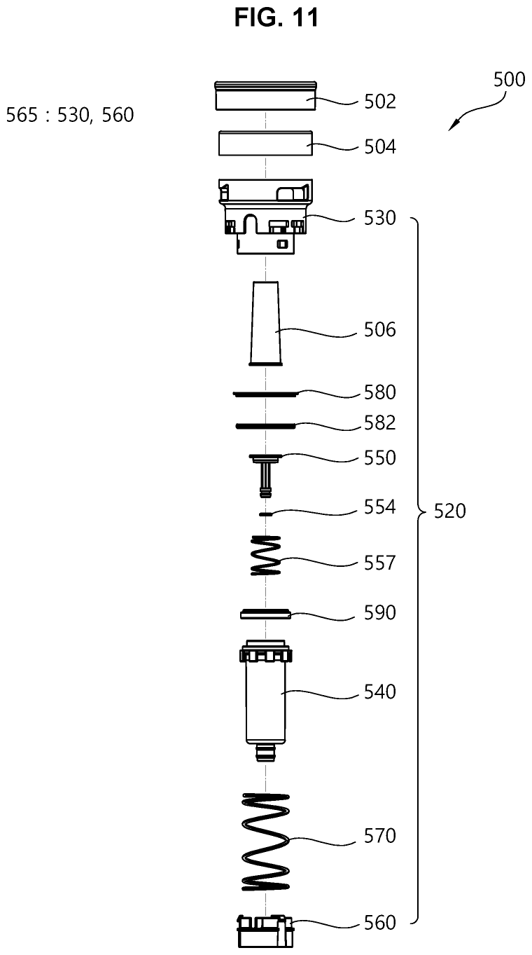

FIG. 10 is a cross-sectional view of the keg cap 520, and FIG. 11 is an exploded side view of the keg cap 520. FIG. 11 shows the cap cover 502 and the fixing gasket 504 together.

Referring to FIGS. 10 and 11, the keg cap 520 may include a cap body 565 connected to the keg 80 and a cap moving member 540 that is movable up and down inside the cap body 565, opens and closes a gas discharge flow path 700 through which gas moves, and provides an undiluted solution discharge flow path 546 through which an undiluted solution moves.

That is, in the case of the keg cap 520 according to the present disclosure, the gas discharge flow path 700 may be more reliably open and closed by opening and closing the gas discharge flow path 700 by the cap moving member 540 having a body extending vertically rather than simply opening and closing the gas discharge flow path by moving only a sealing part vertically as in the cited reference. In addition, in the case of the present disclosure, when the cap moving member 540 moves up and down inside the cap body 565, the cap body 565 guides the up and down movement of the cap moving member 540 to efficiently perform opening and closing of the path 700.

The cap body 565 may include a cap upper body 530 connected to the keg 80 and a cap lower body 560 connected to a lower part of the cap upper body 530.

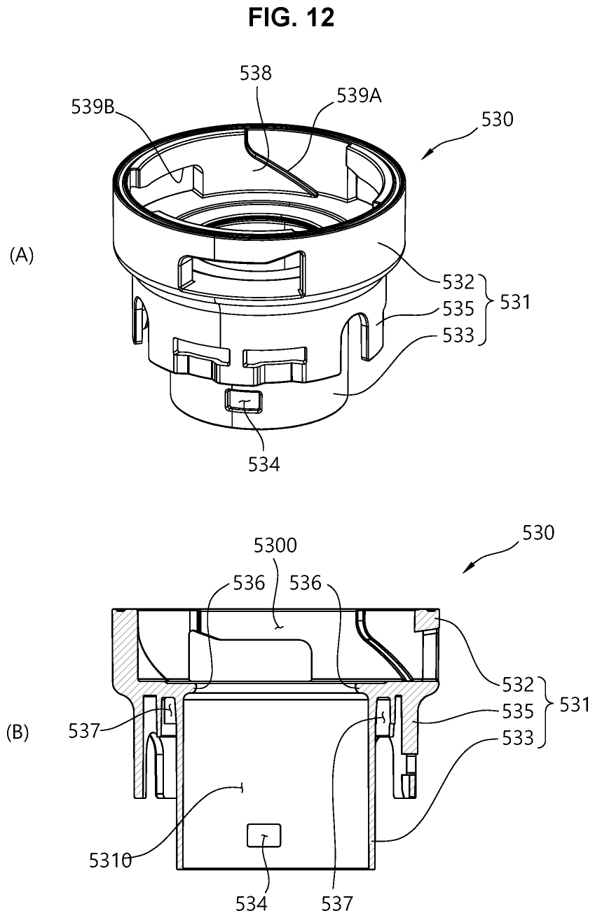

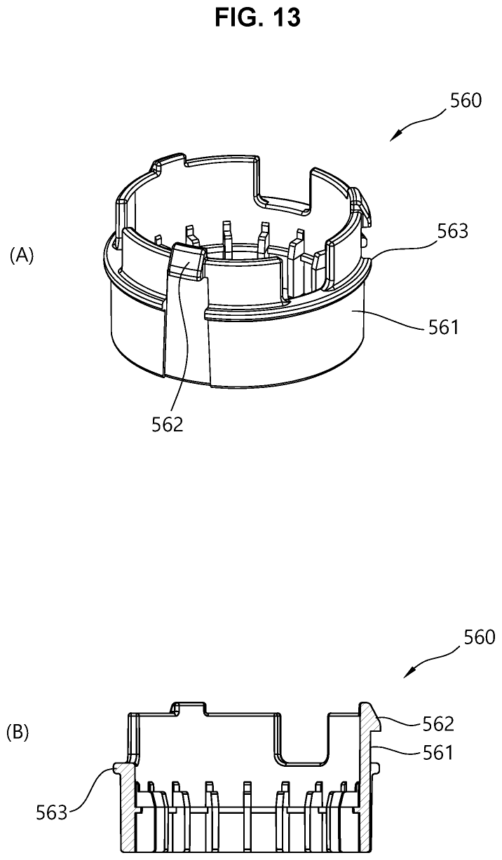

FIG. 12 is a view showing the cap upper body 530, and FIG. 13 is a view showing the cap lower body 560. (A) of FIG. 12 is an upper perspective view of the cap upper body 530, and (B) of FIG. 12 is a side cross-sectional view of the cap upper body 530. In addition, (A) of FIG. 13 is an upper perspective view of the cap lower body 560, and (B) of FIG. 13 is a side sectional view of the cap lower body 560.

Referring to FIGS. 10, 12, and 13, the cap upper body 530 may have a shape corresponding to an opening (not shown) of the keg 80, and is shown in a circular shape in the drawings, but the present disclosure is not limited thereto.

The cap upper body 530 includes a first body 532 with an open top, a second body 535 connected to the lower part of the first body 532, and a third body 533 connected to a lower part of the first body 532 inside the second body 535.

A first opening 5300 may be formed inside the first body 532, and a second opening 5310 may be formed inside the third body 533.

The coupler 600 described later may be connected to the first opening 5300, and the cap moving member 540 described later may be disposed in the second opening 5310.

The first opening 5300 and the second opening 5310 may communicate with each other and may have different sizes. For example, the first opening 5300 may be relatively larger than the second opening 5310.

In this case, a protrusion 536 may be formed inside a connection part in which the first opening 5300 and the second opening 5310 are connected. The protrusion 536 opens and closes the gas discharge flow path 700 when the cap moving member 540 is disposed inside the second opening 5310. This will be explained later.

A guide part 538 may be further provided inside the first body 532. As will be described later, when the guide part 538 is connected to the coupler 600, the guide part 538 guides movement of a hook part 693 of the coupler to be fastened thereto.

For example, the guide part 538 may include an inclined part 539A which guides movement of the hook part 693 of the coupler 600 when the coupler 600 is fastened, and a staircase 539B to which the hook part 693 is coupled.

The guide part 538 may protrude from an inner wall of the first body 532 toward an inner side with a predetermined thickness. In this case, the inclined part 539A for guiding movement of the hook part 693 may be inclined and formed on one side of the guide part 538.

When the coupler 600 is rotated to fasten the coupler 600, the hook part 693 of the coupler 600 moves downward along the inclined part 539A, and is fastened and fixed to the staircase 539B of the neighboring guide part 538.

Therefore, when the coupler 600 is connected to the keg cap 520, the coupler 600 may be connected more quickly and effectively than in the case of using a structure such as a screw thread.

One or more fastening holes 534 may be formed in the third body 533. When the cap lower body 560 is connected, the hook 562 of the cap lower body 560 may be fastened to the fastening hole 534.

An o-ring guide 580 and an o-ring 582 may be disposed in a space 537 between the second body 535 and the third body 533. The o-ring 582 may pressurize the third body 533 from the outside to the inside when the cap moving member 540 is connected to the inside of the cap body 565 to more effectively close the gas discharge flow path 700.

The cap lower body 560 may include a torso part 561 and a hook 562 formed on an upper end part of the torso part 561. The hook 562 may be fastened to the fastening hole 534 of the cap upper body 530 and connect the cap lower body 560 to the cap upper body 530.

A support 563 is formed on at least a part of the upper end part of the torso part 561 to support at least a part of the lower end part of the cap upper body 530.

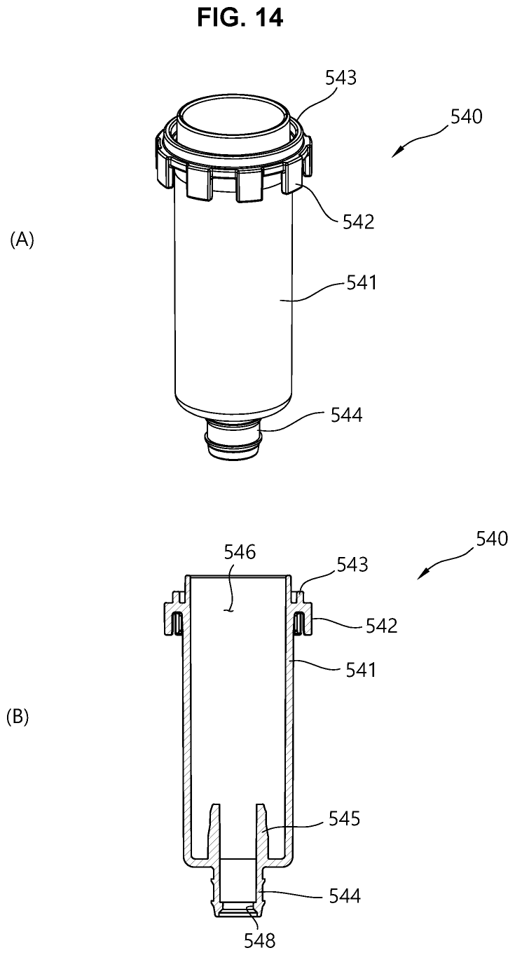

FIG. 14 shows the cap moving member 540 disposed inside the cap body 565. (A) in FIG. 14 is a perspective view of the cap moving member 540, and (B) in FIG. 14 is a side cross-sectional view of the cap moving member 540.

Referring to FIGS. 10 and 14, the cap moving member 540 may include a torso part 541 that extends vertically by a predetermined length to provide the undiluted solution discharge flow path 546.

The undiluted solution discharge flow path 546 may define a flow path through which an undiluted solution inside the keg 80 is discharged, and furthermore, when the capsule 506 containing yeast or the like is mounted on the keg cap 520, the capsule 506 may be inserted and accommodated in a space of the undiluted solution discharge flow path 546.

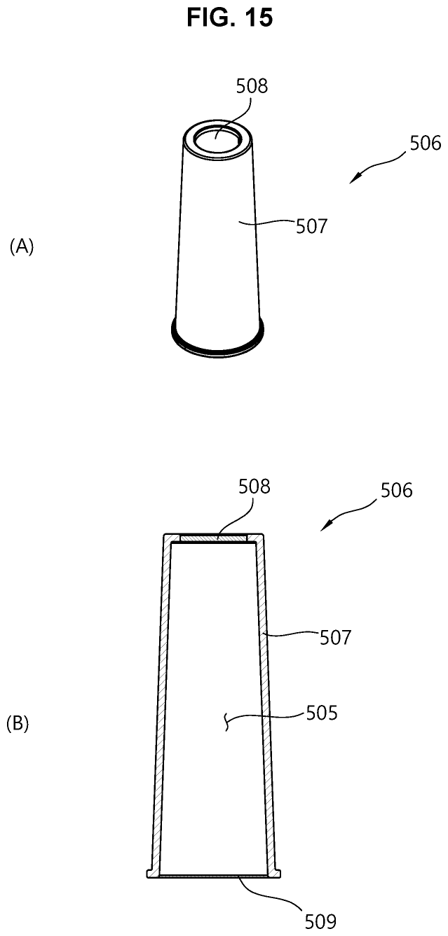

FIG. 15 is a view showing the capsule 506. (A) in FIG. 15 is a perspective view of the capsule 506, and (B) in FIG. 15 is a side cross-sectional view of the capsule 506.

Referring to FIG. 15, the capsule 506 provides an accommodation space 505 for accommodating yeast or the like therein. Yeast is mainly accommodated in the accommodation space 505, but the present disclosure is not limited thereto, and a material other than yeast may be accommodated depending on the purpose.

An upper part of the body 507 of the capsule 506 may have a smaller cross-sectional area than a lower part. That is, when the capsule 506 is viewed from the side, the capsule 506 may have a substantially trapezoidal shape. This is to allow the capsule 506 to stand accurately in a vertical direction without tilting to one side when the capsule 506 is disposed inside the cap moving member 540.

An upper sealing part 508 for closing an upper opening of the capsule 506 is provided, and a lower sealing part 507 for closing a lower opening is provided for a lower portion of the capsule 506. The capsule 506 is manufactured by washing and disinfecting, sealing one side of an upper or lower part with the sealing part, injecting yeast into the inside, and blocking the other side with the sealing part.

Referring to FIGS. 10 and 14, the torso part 541 may extend vertically and have an open top and bottom. Accordingly, an inner space of the torso part 541 may define the undiluted solution discharge flow path 546 through which an undiluted solution moves.

When the cap moving member 540 is disposed inside the cap body 565 described above, the gas discharge flow path 700 may be formed between an inner wall of the cap body 565 and an outer wall of the cap moving member 540.

Therefore, in the present embodiment, no separate process is required to form the gas discharge flow path 700, a space between an inner wall of the cap body 565 and an outer wall of the cap moving member 540 may naturally define the gas discharge flow path 700 when the cap moving member 540 is disposed inside the cap body 565.

In this case, the cap moving member 540 may further include a first sealing member 590 sealing the gas discharge flow path.

When the first sealing member 590 pressurizes the protrusion 536 of the cap body 565, the gas discharge flow path 700 is closed, and when the first sealing member 590 is separated from the protrusion 536, the gas discharge flow path 700 is open.

A connector 542 to which the first sealing member 590 is connected may be provided on the outer wall of the cap moving member 540.

The connector 542 may protrude in an ‘L’ shape from an outer wall of the torso part 541 toward the outside. In this case, an accommodation part 543 to which the first sealing member 590 is seated and connected may be formed above the connector 542.

The connectors 542 may be provided at predetermined intervals along the outer wall of the torso part 541 of the cap moving member 540.

When the cap moving member 540 is disposed inside the cap body 565, the connector 542 may slidably contact the inner wall of the cap body 565.

Therefore, when the cap moving member 540 moves up and down, the connector 542 may slidably move on the inner wall of the cap body 565, and thus the gas discharge flow path 700 may be effectively open and closed by accurately moving the cap moving member 540 in a vertical direction.

When the capsule 506 is accommodated inside the cap moving member 540 as described above, the cap moving member 540 that breaks the lower sealing part 507 of the capsule 506 may be provided inside the cap moving member 540.

The cap blade part 545 may protrude from an inner lower portion of the torso part 541 of the cap moving member 540 upward. In this case, an upper end part of the cap blade part 545 may have a shape in which a thickness or width is narrowed to be suitable for breaking the lower sealing part 507 of the capsule 506.

A fastener 544 protruding downward may be formed at a lower portion of the torso part 541. The aforementioned undiluted solution hose 510 may be connected to the fastener 544.

A protrusion 548 having an opening with a reduced width may be formed inside the lower end part of the fastener 544. The protrusion 548 may be sealed by a second sealing member 554 of a capsule support 550 described below.

When the cap moving member 540 is disposed inside the cap body 565, a first elastic member 570 supporting the cap moving member 540 may be provided.

The first elastic member 570 may be disposed between the lower portion of the connector 542 and the cap lower body 560 to elastically press the cap moving member 540 upward.

When the cap moving member 540 is pressed upward by the first elastic member 570, the first sealing member 590 presses the protrusion 536 of the cap body 565 to close the gas discharge flow path 700.

The capsule support 550 that supports the lower end part of the capsule 506, is movable vertically, and includes the second sealing member 554 opening and closing the undiluted solution discharge flow path 546 of the cap moving member 540 may be provided inside the cap moving member 540.

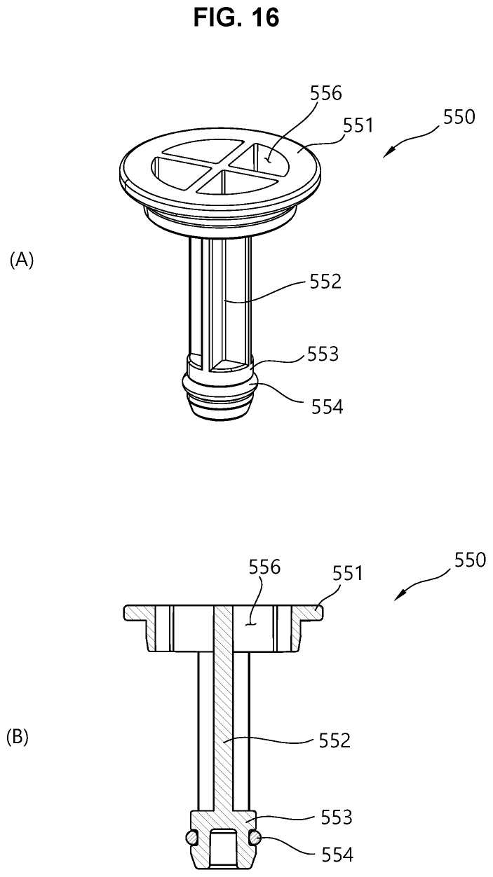

FIG. 16 is a view showing the capsule support 550. (A) in FIG. 16 is a perspective view of the capsule support 550, and (B) in FIG. 16 is a side cross-sectional view of the capsule support 550.

Referring to FIGS. 10 and 16, the capsule support 550 may have an approximate ‘T’ shape when viewed from the side.

For example, the capsule support 550 may include an upper body 551 in which a communication hole 556 is formed to define a flow path through which an undiluted solution moves, an extension support 552 extending downward from a lower part of the upper body 551, and a lower body 553 provided at a lower end part of the extension support 552 and connected to the second sealing member 554.

The capsule support 550 may be inserted into the cap moving member 540 through an opening of an upper end of the cap moving member 540. In this case, the cap blade part 545 described above may be inserted into the communication hole 556 of the upper body 551 and disposed, and the extension support 552 protrudes through the fastener 544 at the lower part of the cap moving member 540. Accordingly, the lower body 553 is located below the fastener 544.

When the capsule support 550 is disposed inside the cap moving member 540, the capsule support 550 may be elastically supported by a second elastic member 557 provided on an inner lower part of the cap moving member 540.

When the second elastic member 557 elastically presses the capsule support 550 upward, the second sealing member 554 may be pressed against the protrusion 548 inside the lower end part of the fastener 544 to be sealed.

When the capsule support 550 moves downward, the second sealing member 554 is separated from the protrusion 548 inside the lower end part of the fastener 544 to open the undiluted solution discharge flow path 546.

Here, the capsule support is a component for opening the undiluted solution discharge flow path when the coupler is fastened and pressurized downward. Therefore, the capsule support may be referred to as a pressure valve. The pressure valve is provided to selectively come into close contact with a fastener of a cap moving member through a sealing member. The close contact may be maintained elastically in a state in which no pressure is applied to the pressure valve, and the close contact release, that is, opening of the undiluted solution discharge flow path may be a state in which the pressure valve is pressed and moved downward.

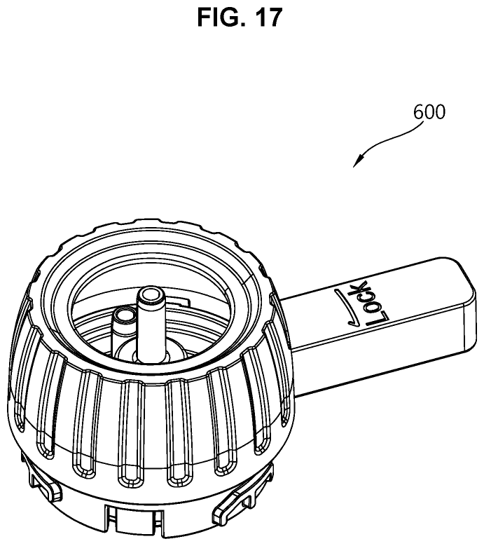

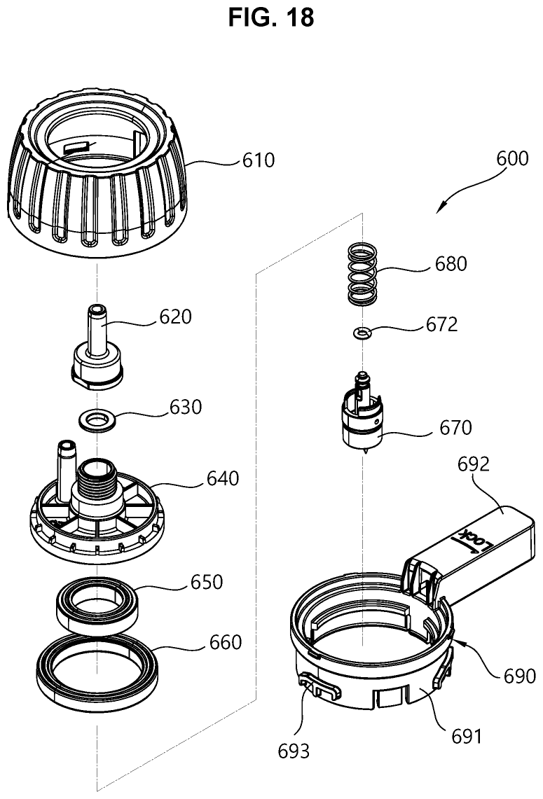

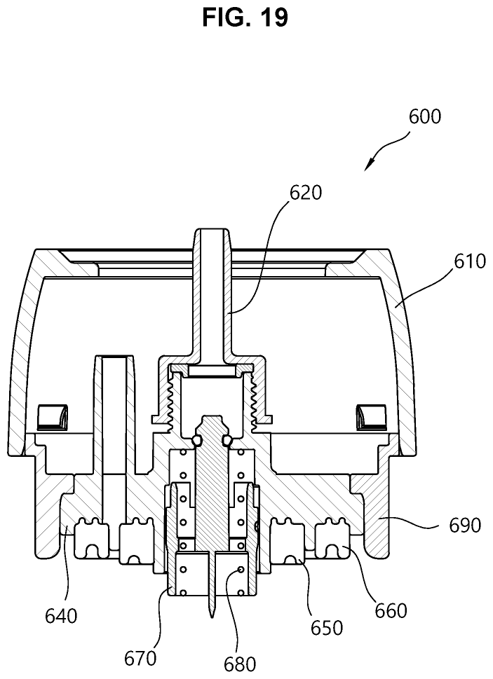

FIG. 17 is a perspective view of the coupler 600 disposed in the keg chamber 10 described above and connected to the keg cap 520 of the keg 80, FIG. 18 is an exploded perspective view of the coupler 600, and FIG. 19 is a side cross-sectional view of the coupler 600.

Referring to FIGS. 17 to 19, the coupler 600 includes a coupler body 640 that provides an undiluted solution flow path 6400 through which undiluted solution moves and a gas flow path 645 through which gas moves, a coupler outer wall 690 connected to the coupler body 640 to be connected to the keg cap 520, and a coupler moving member 670 disposed to be movable up and down inside the coupler body 640 to open and close the undiluted solution flow path 6400.

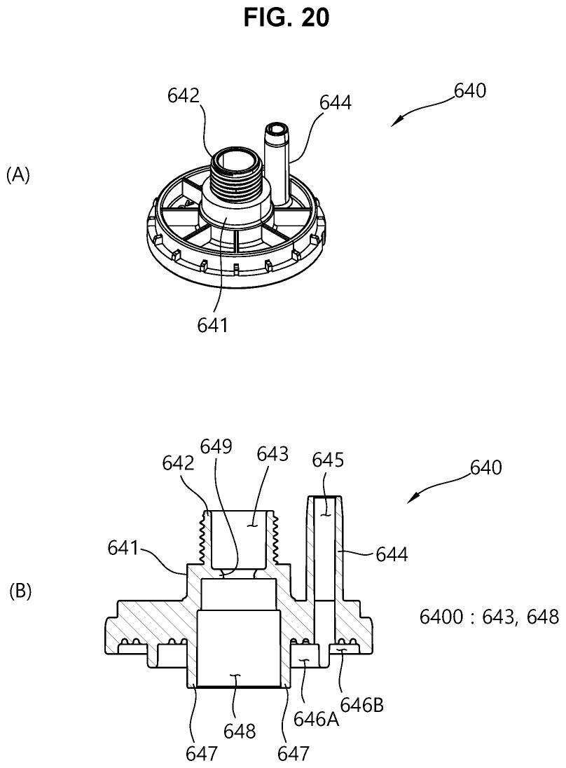

FIG. 20 is a view showing the coupler body 640. (A) in FIG. 20 is a perspective view of the coupler body 640, and FIG. 20(B) is a side sectional view of the coupler body 640.

Referring to FIGS. 19 and 20, the coupler body 640 may include a torso part 641. Openings 643 and 648 defining the undiluted solution flow path 6400 are formed in the torso part 641. The openings 643 and 648 include a first opening 643 and a second opening 648, and the first opening 643 and the second opening 648 may communicate with each other. The undiluted solution flow path 6400 may be connected to the undiluted solution discharge flow path 546 of the keg cap 520 described above.

The first opening 643 may be formed inside the upper protruding connector 642. An additional connection member 620 may be connected to an upper portion of the protruding connector 642 to extend an undiluted solution flow path upward. The undiluted solution flow path may be connected to the aforementioned flow path module. A gasket 630 may be disposed between the protruding connector 642 and the additional connection member 620.

A protrusion 649 may be formed between the first opening 643 and the second opening 648. A third sealing member 672 of the coupler moving member 670 to be described later may pressurize and seal the protrusion 649. This will be described in detail later.

The coupler moving member 670 may be vertically movable in the second opening 648. When the coupler moving member 670 moves up and down, the third sealing member 672 opens or closes the undiluted solution flow path.

An extension 644 providing the gas flow path 645 may be formed on one side of the torso part 641 of the coupler body 640.

The gas flow path 645 is formed inside the extension 644, and the gas flow path 645 may be connected to the gas discharge flow path 700 of the keg cap 520 described above.

Insertion spaces 646A and 646B into which a sealing member for sealing the gas flow path 645 is inserted may be provided on a lower surface of the torso part 641.

For example, a fourth sealing member 650 may be inserted and disposed in a first insertion space 646A, and a fifth sealing member 660 may be inserted and disposed in a second insertion space 646b.

In this case, when the coupler 600 is connected to the keg cap 520 and descends, the fourth sealing member 650 pressurizes the first sealing member 590 sealing the gas discharge flow path 700 of the keg cap 520 to pressurize the gas discharge flow path 700.

A capsule pressurizer 647 for pressurizing the capsule 506 may be further provided below the coupler body 640.

When the coupler 600 is connected to the keg cap 520, the capsule pressurizer 647 pressurizes an upper end part of the capsule 506. In this case, the capsule 506 and the capsule support 550 descend, and the cap blade part 545 breaks the lower sealing part 507 of the capsule 506.

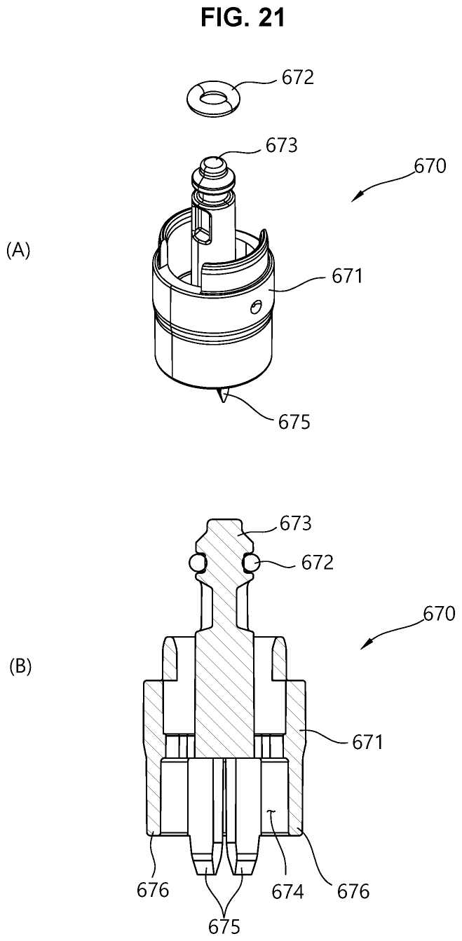

FIG. 21 is a view showing the coupler moving member 670. (A) in FIG. 21 is a perspective view of the coupler moving member 670, and (B) in FIG. 21 is a side cross-sectional view of the coupler moving member 670.

Referring to FIGS. 19 and 21, the coupler moving member 670 may include a torso part 671.

A protrusion 673 protrudes upward from the upper part of the torso part 671, and the third sealing member 672 is provided on at an upper end part of the protrusion 673.

The third sealing member 672 pressurizes the protrusion 649 of the coupler body 640 to seal the undiluted solution flow path 6400. In this case, the coupler moving member 670 may be elastically supported by a third elastic member 680 inside the coupler body 640.

That is, when the third elastic member 680 elastically presses the coupler moving member 670 downward, the third sealing member 672 presses the protrusion 649 of the coupler body 640 to seal the undiluted solution flow path 6400.

When the coupler moving member 670 moves upward by connecting the coupler 600 to the keg cap 520, the third sealing member 672 is spaced apart from the protrusion 649 of the coupler body 640 to open the undiluted solution flow path 6400.

An opening 674 providing a flow path through which an undiluted solution moves may be formed inside the torso part 671. An undiluted solution moves through the opening 674.

A coupler blade 675 breaking the upper sealing part 508 of the capsule 506 may be provided at a lower part of the torso part 671.

That is, when the coupler 600 is connected to the keg cap 520, the coupler blade 675 breaks the upper sealing part 508 of the capsule 506.

To this end, the lower end part of the coupler blade 675 protrudes most downward from the coupler 600 and is provided.

That is, when comparing degrees of protrusion of the lower end parts of the coupler blade 675, the capsule pressurizer 647, and the fourth sealing member 650 described above, the coupler blade 675, the capsule pressurizer 647, and the fourth sealing member 650 may protrude in the order stated. The degrees of protrusion are for effectively breaking the upper sealing part 508 and the lower sealing part 507 of the capsule 506 when the coupler 600 is connected to the keg cap 520. This will be described in detail later.

A lower end part 376 of the coupler moving member 670 comes into contact with the upper end part of the capsule 506. When the lower end part 376 of the coupler moving member 670 comes into contact with the upper end part of the capsule 506, the coupler moving member 670 is pressed upward and the coupler moving member 670 rises. In this case, the third sealing member 672 is separated from the protrusion 649 of the coupler body 640 to open the undiluted solution flow path 6400.

Referring to FIG. 18, the coupler outer wall 690 may further include the hook part 693 coupled to the keg cap 520, and a handle 692 rotating the coupler 600.

The hook part 693 may protrude outward from the coupler outer wall 690 and be fastened to the guide part 538 of the cap body 565 described above.

That is, when a user rotates the coupler 600 to fasten the coupler 600 using the handle 692, the hook part 693 of the coupler 600 moves downward along the inclined part 539A and is fastened and fixed to the staircase 539B of the neighboring guide part 538.

The coupler 600 may further include a cover 610 connected to the coupler outer wall 690. The cover 610 has an open upper portion and is arranged to surround the coupler 600 to protect components of the coupler 600.

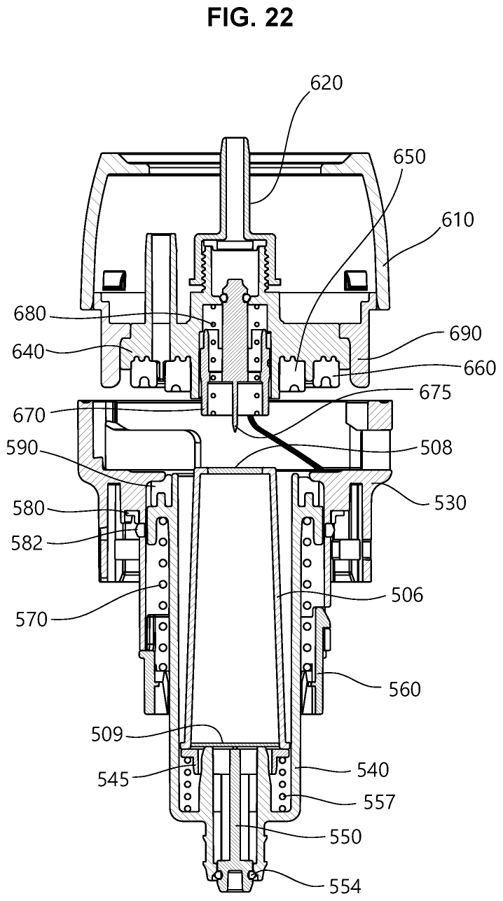

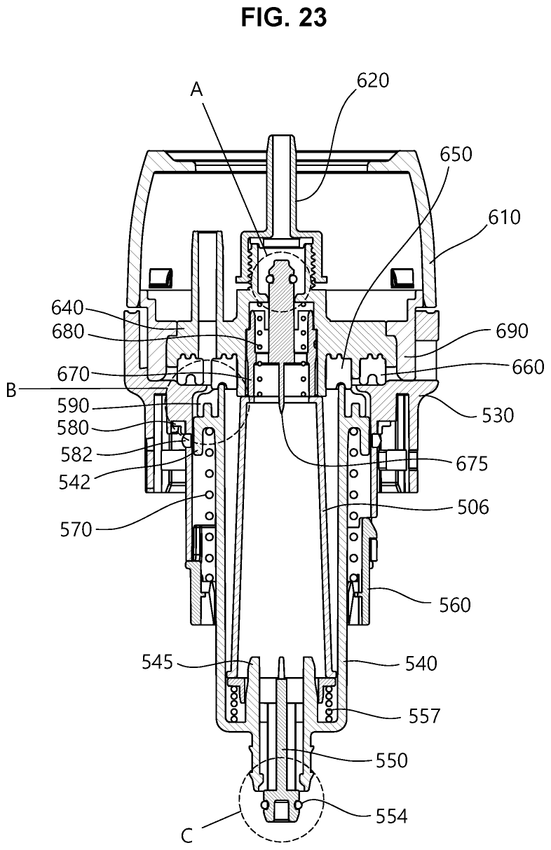

FIG. 22 is a side cross-sectional view showing a situation before connecting the coupler 600 to the keg cap 520, and FIG. 23 is a side cross-sectional view showing a situation in which the coupler 600 is connected to the keg cap 520.

Referring to FIGS. 22 and 23, when a user rotates the coupler 600 using the handle 692, the hook part 693 of the coupler 600 moves downward along the inclined part 539A, and fastened and fixed to the staircase 539B of the neighboring guide part 538.

At this time, since the lower end part of the coupler blade 675 protrudes most downward from the coupler 600, when the coupler 600 is connected to the keg cap 520, the coupler blade 675 breaks the upper sealing part 508 of the capsule 506.

Subsequently, the lower end part 376 of the coupler moving member 670 comes into contact with the upper end part of the capsule 506. When the lower end part 376 of the coupler moving member 670 comes into contact with the upper end part of the capsule 506, the coupler moving member 670 is pressed upward and the coupler moving member 670 rises.

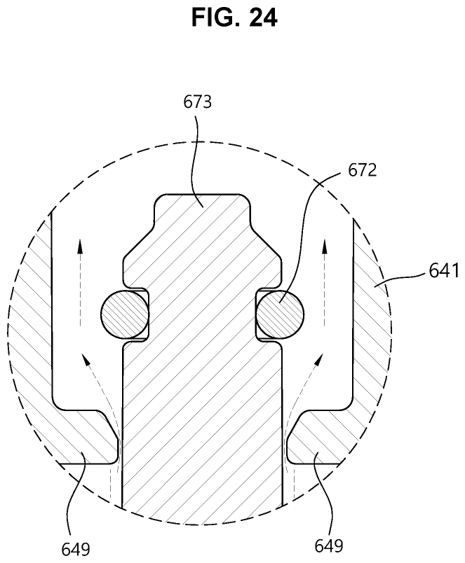

FIG. 24 is an enlarged view of an area ‘A’ in FIG. 23. As shown in FIG. 24, the third sealing member 672 is separated from the protrusion 649 of the coupler body 640 to open the undiluted solution flow path 6400.

The lower end part 376 of the coupler moving member 670 comes into contact with the upper end part of the capsule 506, and simultaneously or subsequently, the capsule pressurizer 647 pressurizes the upper end part of the capsule 506.

In this case, the capsule 506 and the capsule support 550 descend, and the cap blade part 545 breaks the lower sealing part 507 of the capsule 506.

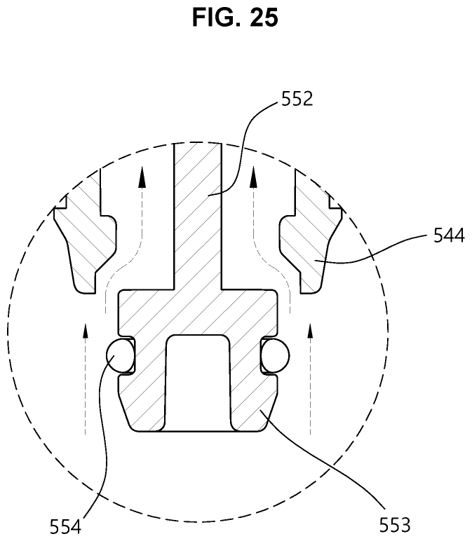

FIG. 25 is an enlarged view of an area ‘C’ in FIG. 23. As shown in FIG. 25, when the capsule support 550 descends, the second sealing member 554 is separated from the protrusion 548 inside the lower end part of the fastener 544 to open the undiluted solution discharge flow path 546.

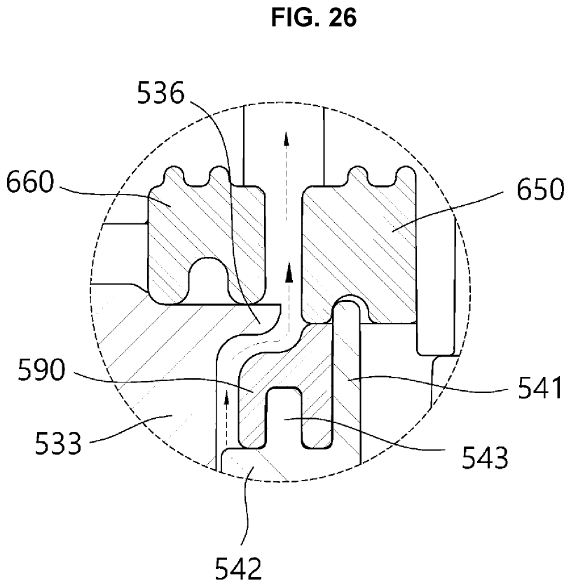

Subsequently, as shown in FIG. 26, the fourth sealing member 650 presses the first sealing member 590 sealing the gas discharge flow path 700 of the keg cap 520 to open the gas discharge flow path 700. FIG. 26 is an enlarged view of an area ‘B’ in FIG. 23.

In the above, an embodiment in which a fermented beverage dispensing apparatus for dispensing fermented beverage in a fermented beverage manufacturing apparatus has been described. However, the fermented beverage manufacturing apparatus and the fermented beverage dispensing apparatus may be formed through separate cases. That is, in the fermented beverage manufacturing apparatus, only fermented beverage is manufactured, and a separate fermented beverage dispensing apparatus may be provided to dispense the fermented beverage. In the latter case, flow paths through which fermented beverage and carbon dioxide are introduced may be connected between the fermented beverage manufacturing apparatus and the fermented beverage dispensing apparatus.

Therefore, the fermented beverage manufacturing apparatus according to an embodiment of the present disclosure may be separately manufactured and installed as an apparatus for manufacturing fermented beverage and an apparatus for dispensing fermented beverage. Flow paths connecting the two apparatuses may be equally applicable. However, the flow paths may be provided to connect between the two apparatuses without being entirely provided in one apparatus.

Although the above has been described with reference to the exemplary embodiments of the present disclosure, those skilled in the art will variously modify and change the present disclosure within the scope not departing from the spirit and scope of the present disclosure described in the claims described below. Therefore, if the modified implementation basically includes the elements of the claims of the present disclosure, all of the elements need to be considered to be included in the scope of the present disclosure.

### INDUSTRIAL AVAILABILITY

This is included in the detailed description of the present disclosure.

1-20. (canceled)

21. A keg cap comprising:
a cap body connected to a keg; and
a cap moving member movable up and down inside the cap body, opening and closing a gas discharge flow path through which gas inside the keg moves, and providing an undiluted solution discharge flow path in which an undiluted solution moves.

22. The keg cap of claim 21, wherein the gas discharge flow path is formed between an inner wall of the cap body and an outer wall of the cap moving member.

23. The keg cap of claim 22, further comprising:
a first sealing member sealing the gas discharge flow path.

24. The keg cap of claim 23, further comprising:
a connector connected to the first sealing member on an outer wall of the cap moving member.

25. The keg cap of claim 24, wherein the connector is provided on the outer wall of the cap moving member at a predetermined interval, and slidably contacts the inner wall of the cap body.

26. The keg cap of claim of claim 21, further comprising:
a first elastic member provided inside the cap body to support the cap moving member.

27. The keg cap of claim of claim 26, wherein the cap body includes:
a cap upper body connected to an opening of the keg; and
a cap lower body connected to a lower part of the cap upper body to support the first elastic member.

28. The keg cap of claim of claim 21, further comprising:
when a capsule is accommodated inside the cap moving member,
a capsule support including a cap blade provided inside the cap moving member to break a lower sealing part of the capsule, and a second sealing member supporting a lower end part of the capsule inside the cap moving member, moveable up and down, and opening and closing an undiluted solution discharge flow path of the cap moving member.

29. The keg cap of claim of claim 28, wherein the capsule support is elastically supported by a second elastic member provided in a lower part of an inside of the cap moving member, and when the capsule is pressed downward, the capsule support descends, the lower sealing part of the capsule is broken by the cap blade part, and the undiluted solution discharge flow path is open.

30. The keg cap of claim of claim 21, wherein:
the cap body further includes a guide part; and
the guide part includes an inclined part guiding movement of a hook part of a coupler when the coupler is connected, and a staircase to which the hook part is fastened.

31. A keg including the keg cap of claim 21.

32. A keg cap coupled to a coupler of a flow path module for preparing a fermented beverage through an undiluted solution and included in a keg accommodating the undiluted solution, the keg cap comprising:
a cap body connected to the keg; and
a cap moving member movable up and down inside the cap body, opening and closing a gas discharge flow path through which gas inside the keg moves, and providing an undiluted solution discharge flow path in which an undiluted solution moves,
wherein, when the coupler is coupled to the keg cap, the gas discharge flow path communicates with a gas flow path of the flow path module, and the undiluted solution discharge flow path communicates with an undiluted solution flow path of the flow path module.

33. The keg cap of claim 32, wherein the keg cap is an integral keg cap in which a capsule containing yeast is embedded.

34. A keg cap coupled to a coupler of a flow path module for preparing a fermented beverage through an undiluted solution and included in a keg accommodating the undiluted solution, the keg cap comprising:
a cap body connected to the keg;
a cap moving member formed in a cylindrical shape having a hollow constituting an undiluted solution discharge flow path and moving downward by being pressurized when the cap body is coupled to the coupler; and
a first sealing member provided on an upper part of the cap moving member and moving downward together with the cap moving member to open a gas discharge flow path formed between an inner side of the cap body and an outer side of the cap moving member,
wherein, when coupled to the coupler, an upper end part of the cap moving member is pressurized by the sealing member of the coupler to block communication between the undiluted solution discharge flow path and the gas discharge flow path through the upper end part of the cap moving member.

35. The keg cap of claim 34, wherein the cap moving member includes:
a cylindrical body having a hollow;
a fastener having a hollow smaller than the hollow of the body at a lower center of the body and having an outer diameter smaller than an outer diameter of the body; and
a pressure valve provided to be pressurized and moved downward when coupled to the coupler and open the undiluted solution discharge flow path.

36. The keg cap of claim 35, wherein the body and the fastener are integrally formed, and when coupled to the coupler, a downward displacement of the pressure valve is greater than a downward displacement of the body and the fastener.

37. The keg cap of claim 35, wherein a capsule accommodating yeast is accommodated in the hollow of the body.

38. The keg cap of claim 37, wherein, when coupled to the coupler, an upper end of the capsule is pressurized downward by the coupler, and a lower end of the capsule pressurizes the body of the pressure valve downward, and the pressure valve is moved downward.

39. The keg cap of claim 38, wherein the cap moving member includes a plurality of cap blades protruding upward into the hollow of the body at predetermined intervals in a circumferential direction from an upper part of the fastener.

40. The keg cap of claim 39, wherein the pressure valve includes:
the body;
a communication hole that is formed in the body and through which the cap blade passes;
an extension support extending downward from a center of the body; and
a sealing member provided in the extension support and provided to open a hollow of the fastener when contact with the fastener is released.
